(19) United States
(12) Patent Application Publication
(10) Pub. No.: US 2001/0010072 A1
(43) Pub. Date: Jul. 26, 2001

(54) Instruction translator translating non-native instructions for a processor into native instructions therefor, instruction memory with such translator, and data processing apparatus using them

(75) Inventor: Toyohiko Yoshida, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/756,863

(22) Filed: Jan. 10, 2001

(30) Foreign Application Priority Data
Jan. 13, 2000 (JP) 2000-005062 (P)

(51) Int. Cl. G06F 9/455

(52) U.S. Cl. 712/209; 712/227; 712/210

(57) ABSTRACT

The instruction translator includes a translator for reading out a corresponding instruction from the instruction memory in response to the received address to be executed by the processor and translating the instruction in a second instruction architecture into an instruction in a first instruction architecture, an instruction cache for temporarily holding the instruction in the first instruction architecture after the translation by the translator in association with the address in the instruction memory, and a selector for searching the instruction cache in response to the received address of an instruction to be executed by the processor, and based on a determination result of whether or not an instruction corresponding to the instruction of the address is held in the instruction cache, selectively outputting an instruction output by the translator, and the corresponding instruction in the first instruction architecture which has been held in the instruction cache.

### BACKGROUND OF THE INVENTION

1. Field of the Invention

The present invention relates to an instruction translator for translating non-native instructions for a processor into native instructions for the processor, a memory with an instruction translator function having such a translator and a data processing apparatus capable of executing a non-native instruction at a high speed using them.

2. Description of the Background Art

A processor architecture and an instruction architecture executable on the processor are closely related to each other. When the instruction architecture is renewed with development of the processor architecture, program codes implemented in the old instruction architecture as they are will usually be not executable. It would be of greater importance how to pass the program asset inherited from the old instruction architecture to a new generation. Thus, a number of approaches have been developed and proposed for enabling a new processor with a new instruction architecture to execute programs written for old processors which had been designed according to old instruction architectures.

One typical conventional approach to execute programs written for an old processor on a new processor is to provide the hardware of the new processor with the function of the old one. Referring to FIG. 1, a conventional data processing apparatus 500 embodying such an approach includes a processor 1 having a multi-function instruction decoder 5 capable of decoding instructions for an old processor and a new processor, an operation unit 6 capable of executing these instructions, a bus 4 connected to processor 1, a data memory 2 connected to bus 4, and an instruction memory 3 connected to bus 4.

Instruction memory 3 holds instructions for both the old and new processors. Multi-function decoder 5 decodes an instruction read out from instruction memory 3 and transferred to processor 1 through bus 4. At this time, multi-function decoder 5 can decode the instruction whether it is for a new processor or an old processor. The decoded instruction is executed by operation unit 6. Data memory 2 is accessible from both sets of instructions for old and new processors.

Such an approach which provides the hardware of a new processor with the function of the hardware of an old processor is for example disclosed in detail in “IA-32 Application Execution Model in an IA-64 System Environment” (IA-64 Application Developer's Architecture Guide, Chapter 6, May, 1999).

Another conventional approach to executing a program written for an old processor on a new processor includes translating the software for the old processor into software for the new processor for execution, and emulating the operation of instructions for the old processor with software for the new processor. These kinds of approaches are for example disclosed in detail in Tom Thompson, “An Alpha in PC Clothing (Digital Equipment's New x86 Emulator Technology Makes an Alpha System a Fast x86 Clone)” (BYTE, pp. 195-196, February 1996).

Meanwhile, executing a program written for an instruction architecture on a processor designed in accordance with another instruction architecture is useful in other cases. For example, if a subset of a certain instruction architecture is defined and a program is written in the reduced instruction architecture, the program size may be reduced. In case of Java language, an instruction architecture for a virtual processor is prescribed for writing a program, and the same program is executed by processors of different kinds with the instruction architectures of respective processors. Thus, programs written in the JAVA language may be commonly executable among processors of different kinds having different instruction architectures.

A number of approaches have been proposed to define a reduced, subset instruction architecture for the purpose of reducing the program sizes and to decode the instructions both in non-reduced and reduced instruction architectures with a multi-function instruction decoder in a processor. See for example, James L. Turley, “Thumb Squeezes ARM Code Size (New Core Module Provides Optimized Second Instruction Set)” (Micro Processor Report, Vol. 9, No. 4, pp. 1, 6-9, Mar. 27, 1995).

Note however that the above-described conventional approaches all suffer from the following disadvantages.

When the hardware of a processor is provided with the function of executing programs written in multiple instruction architectures, the hardware could be complicated, and its size could be large. If it is necessary to accommodate another instruction architecture or one of the architectures are changed, the entire hardware must be redesigned, which impedes flexible designing.

If a program is to be translated by software, the following problem will be encountered. Program translation will require a large amount of additional storage for storing the program after the translation. As a result, the cost of memory will increase, pushing up the cost of the data processing apparatus. When each instruction is to be emulated with an a program in another instruction architecture the result of operation of each instruction must be emulated as well as the value of the program counter and, if necessary, even flags must be emulated. As a result, one instruction must be replaced with a number of instructions in another architecture. Consequently, the operation speed will be significantly lowered.

### SUMMARY OF THE INVENTION

The present invention is directed to a solution to these problems, and it is an object of the present invention to provide a data processing apparatus capable of executing programs written in accordance with a plurality of different instruction architectures at a high speed without changing the hardware of the processor itself and without having to provide a mass capacity memory, an instruction translator and a memory with an instruction translator function therefor.

Another object of the present invention is to provide a data processing apparatus capable of executing programs in accordance with a plurality of different instruction architectures at a high speed using native instructions, without changing the hardware of the processor itself, without having to provide a mass capacity memory, and explicitly emulate a program counter, and permitting the content of an instruction to be readily analyzed, an instruction translator therefor and a memory with an instruction translator function therefor.

Yet another object of the invention is to provide a data processing apparatus capable of executing programs written in accordance with a plurality of different instruction architectures at a high speed using native instructions, without changing the hardware of the processor itself, without having to provide a mass capacity memory, and explicitly emulate a program counter, an instruction translator therefor and a memory with an instruction translator function therefor.

An instruction translator according to the present invention is, in a processor operating with instructions in a first instruction architecture as a native instruction, an instruction translator used with an instruction memory to store an instruction in a second instruction architecture different from the first instruction architecture for translating an instruction in the second instruction architecture into an instruction in the first instruction architecture and for applying them to the processor. The instruction translator includes: a translator for reading out a corresponding instruction from the instruction memory in response to the received address in the memory of an instruction to be executed by the processor and translating the read out instruction in the second instruction architecture into an instruction in the first instruction architecture; an instruction cache for temporarily holding the instruction in the first instruction architecture after the translation by the translator in association with the address in the instruction memory; and a selector for searching the instruction cache in response to the received address of an instruction to be executed by the processor, and based on a determination result of whether or not an instruction corresponding to the instruction of the address is held in the instruction cache, selectively outputting an instruction output by the translator, and the corresponding instruction in the first instruction architecture which has been stored in the instruction cache.

The addition of the instruction translator permits a non-native instruction to be translated into a native instruction for execution by the processor, without changing the structure of the processor itself. When the instruction translated into the first instruction architecture is temporarily stored in the instruction cache and this instruction is read out from the instruction memory, the instruction in the first instruction architecture translated and stored in the instruction cache can be output, so that reading and writing operations from the instruction memory can be omitted, and the translated instruction can be output at a high speed.

The second instruction architecture is preferably a variable length instruction architecture, and the translator includes a variable length translator for translating an instruction in the second instruction architecture read out from the instruction memory into instructions in the first instruction architecture, the number of which depends on the instruction length of the read out instruction in the second instruction architecture.

Since the length of a non-native instruction is emulated with the number of native instructions after the translation, the value of the program counter for the native instructions does not have to be explicitly emulated.

Further preferably, the translator translates the instruction in the second instruction architecture read out from the instruction memory into an instruction in the first instruction architecture depending on the instruction length of the read out instruction in the second instruction architecture and having a length larger than the instruction length. Since the length of a non-native instruction is emulated with the length of a native instruction after the translation depending upon the length of the non-native instruction, the value of the program counter for the non-native instructions does not have to be explicitly emulated. In addition, since the average length of the non-native instructions before the translation is reduced, the program size is reduced, so that the amount of the memory to store programs can be small.

Each instruction in the first instruction architecture preferably includes one or a plurality of sub instructions, and the translator translates a plurality of instructions in the second instruction architecture read out from the instruction memory into an instruction in the first instruction architecture including sub instructions, the number of which depends on the number of the plurality of instructions. Since the plurality of non-native instructions are emulated with a plurality of sub instructions, translation of instructions is easily performed, and the length of a native instruction depends on the number of sub instructions included therein. As a result, the program counter value for the non-native instructions can be emulated with the length of the native instruction after the translation.

The instruction translator according to another aspect of the present invention is, in a processor operating with an instruction in a first instruction architecture as a native instruction, an instruction translator used with an instruction memory to store an instruction in a second instruction architecture different from the first instruction architecture for translating an instruction in the second instruction architecture into an instruction in the first instruction architecture before transferring it to the processor. The instruction translator includes: a translator for reading out a corresponding instruction from the instruction memory in response to the received address of an instruction in the instruction memory to be executed by the processor and translating the read out instruction in the second instruction architecture into one or a plurality of instructions in the first instruction architecture; an instruction cache for temporarily holding an instruction in the first instruction architecture after the translation by the translator in association with the address in the instruction memory; a selector for searching through the instruction cache in response to the received address of an instruction to be executed by the processor, and based on a determination result of whether or not a corresponding instruction to the instruction of the address is stored in the instruction cache; selectively outputting an instruction output by the translator, and the corresponding instruction in the first instruction architecture which has been stored in the instruction cache; and a controller for controlling the cache so that the cache holds an instruction stored in the instruction cache as an entry which can be invalidated in one of the first and second conditions.

Since one non-native instruction is translated into one or a plurality of native instructions to be held in the instruction cache, the native instructions after the translation can be output at a high speed from the instruction cache when the same non-native instruction is read out for the next time. Furthermore, since the first or second condition can be taken for invalidation of the instructions stored in the instruction cache, any complicated invalidation condition such as simultaneous invalidation of a plurality of native instructions can be readily addressed.

Preferably, the first condition is a holding control condition by hardware control based on a prescribed algorithm by the instruction cache, and the second condition is a condition in which an explicit invalidation operation is applied from the outside of the instruction cache. Not only the held content of instruction cache can be maintained under hardware control, but also the contents of the instruction cache can be externally explicitly invalidated, so that the held contents of the instruction cache can be safely maintained on the responsibility of software.

An instruction memory attached with a translator according to yet another aspect of the present invention is used with a processor operating with an instruction in a first instruction architecture as a native instruction and includes: an instruction storage to store an instruction in a second instruction architecture; and an instruction translator to translate an instruction in the second instruction architecture output from the instruction storage into an instruction in the first instruction architecture before transferring it to the processor.

An instruction in the second instruction architecture which has been stored in the instruction storage can be translated into an instruction in the first instruction architecture and transferred to the processor. A program written with non-native instructions can be executed without modifying the processor.

The instruction translator selectively executes one of the processing to translate an instruction in the second instruction architecture into an instruction in the first instruction architecture and the processing of outputting the instruction in the second instruction architecture as is. Not only an instruction in the second instruction architecture can be translated into an instruction in the first instruction architecture and read, but also an instruction in the second instruction architecture can be output as is. As a result, a program in the second instruction architecture can be transferred to another memory or the contents of the program can be analyzed.

The instruction memory attached with a translator further preferably includes: an address translator to translate an address at the time of reading from the instruction storage. Different memory maps can be used for the memory when it is accessed with and without instruction translation.

According to a still further aspect of the present invention, a data processing apparatus includes: a processor operating with an instruction in a first instruction architecture as a native instruction; a bus to which the processor is connected; and an instruction memory with a translator interconnected with the processor through the bus. The instruction memory with a translator includes: an instruction storage to store an instruction in a second instruction architecture transferred from the processor through the bus; and an instruction translator to translate an instruction in the second instruction architecture output from the instruction storage into an instruction in the first instruction architecture when transferring it to the processor through the bus.

Since there is provided an instruction translator which translates instructions in the second instruction architecture not native to the processor into instructions in the first instruction architecture native to the processor, a program written with instructions in the second instruction architecture can be executed by this processor, without changing the structure of the processor.

The data processing apparatus further includes: a second instruction memory interconnected to the processor through the bus, and the second instruction memory includes: an instruction storage to store an instruction in the first instruction architecture transferred from the processor through the bus; and an instruction reading circuit for transferring an instruction in the first instruction architecture output from the instruction storage to the processor through the bus in response to an address signal applied from the processor through the bus.

A program written with instructions of the first instruction architecture can be transferred to the processor from the second memory and executed, and therefore the processor can decode and execute an instruction regardless of whether it is a non-native instruction or a native instruction, without changing the processor itself.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a conventional data processing apparatus with a conventional instruction emulation function;

FIG. 2 is a block diagram of a data processing apparatus with an instruction translator function according to one embodiment of the present invention;

FIG. 3 is a block diagram of processor 10 shown in FIG. 2;

FIG. 4 is a table including a list of registers in processor 10;

FIG. 5 is a diagram showing in detail a control register in processor 10;

FIG. 6 is a diagram for use in illustration of a pipeline processing mechanism in processor 10;

FIG. 7 is a diagram showing a format of a VLIW (Very Long Instruction Word) instruction executable by processor 10;

FIG. 8 is a diagram showing a format of a VLIW instruction executable by processor 10;

FIG. 9 is a diagram showing a method of pipelining sub instructions by processor 10;

FIG. 10 is a diagram showing a method of pipelining two sub instructions by processor 10;

FIG. 11 is a memory map for a data processing apparatus shown in FIG. 2;

FIG. 12 is a diagram showing in detail a memory 24 with a translator for a compressed instruction to expand the compressed instruction in the data processing apparatus in FIG. 12;

FIG. 13 is a diagram showing in detail a translation circuit 243 to translate a compressed instruction;

FIG. 14 is a diagram showing in detail a cache memory 354 shown in FIG. 13;

FIG. 15 is a timing chart showing a bus cycle for the data processing apparatus shown in FIG. 2;

FIG. 16 is a diagram showing correspondence between bit fields when two compressed instructions are uncompressed into a VLIW instruction;

FIGS. 17 to 20 are diagrams each showing a specific example of how a compressed instruction is uncompressed;

FIG. 21 is a diagram showing a series of general-purpose registers which can be accessed with a compressed instruction in a data processing apparatus according to this embodiment;

FIG. 22 is a diagram showing in detail a memory 25 with a translator for JAVA instructions shown in FIG. 2;

FIG. 23 is a diagram showing in detail a translation circuit 263 for JAVA instructions;

FIG. 24 is a diagram showing in detail a cache memory 374 having an entry which can be invalidated only by software;

FIG. 25 is a diagram showing correspondence between instructions when a JAVA instruction is translated into one or a plurality of VLIW instructions;

FIGS. 26 to 31 are diagrams each showing a specific example of how a JAVA instruction is translated into a VLIW instruction or VLIW instructions; and

FIG. 32 is a flow chart for use in illustration of the flow of processing when the data processing apparatus in FIG. 2 emulates JAVA instructions.

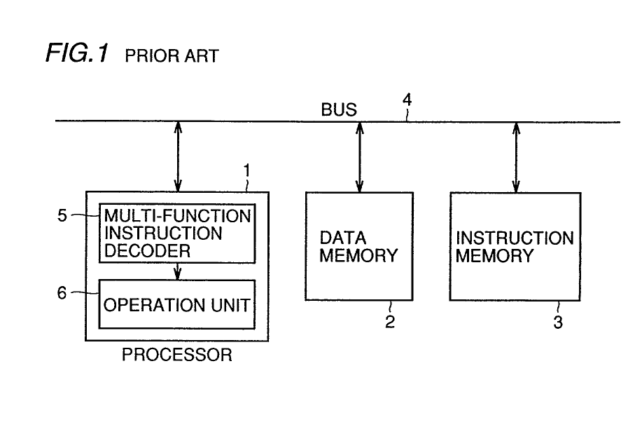

### DESCRIPTION OF THE PREFERRED EMBODIMENTS

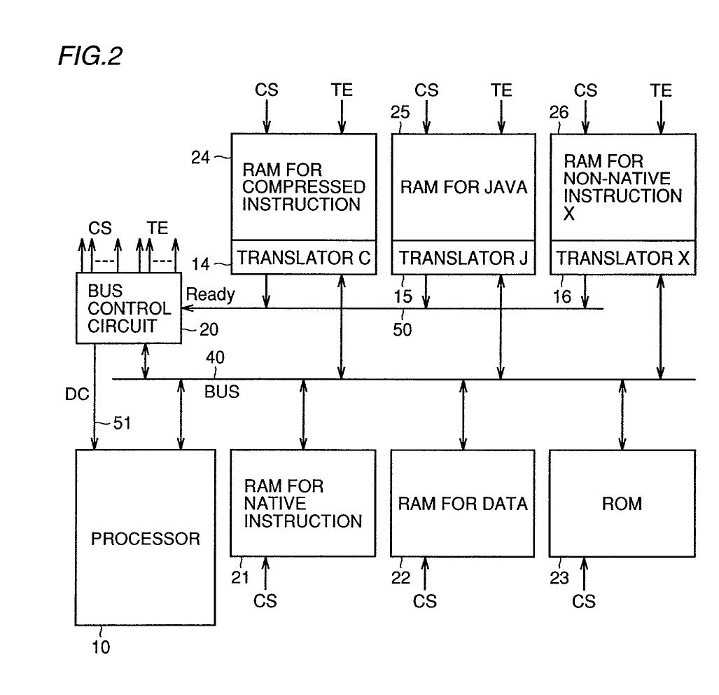

Referring to FIG. 2, a data processing apparatus according to an embodiment of the present invention includes: a processor 10, a bus 40 connected to processor 10; a bus control circuit 20 connected to bus 40, a READY signal line 50 and processor 10; a memory 24 with a translator for compressed instruction having a translator 14, a memory 25 with a translator for JAVA instruction having a translator 15, and a memory 26 with a translator for non-native instruction X having a translator 16 all connected to READY signal line 50 and bus 40; a RAM 21 for native instruction, a data memory 22, and a ROM 23 to store a native instruction, a compressed instruction, a JAVA instruction, a non-native instruction X and data all connected to bus 40.

Bus control circuit 20 decodes an address outputted from processor 10 onto bus 40, and outputs a chip select signal CS, which activates one of RAM 21 for native instructions, data memory 22, ROM 23, memory 24 with translator for compressed instructions, memory 25 with translator for JAVA instructions, and memory 26 with translator for non-native instructions X. Bus control circuit 20 also outputs a translation function enable signal TE to translators 14 to 16, to control these instruction translation functions. Bus control circuit 20 receives a READY signal conveyed on READY signal line 50 from translators 14 to 16, and applies a DC signal 51 representing the end of a bus cycle to processor 10.

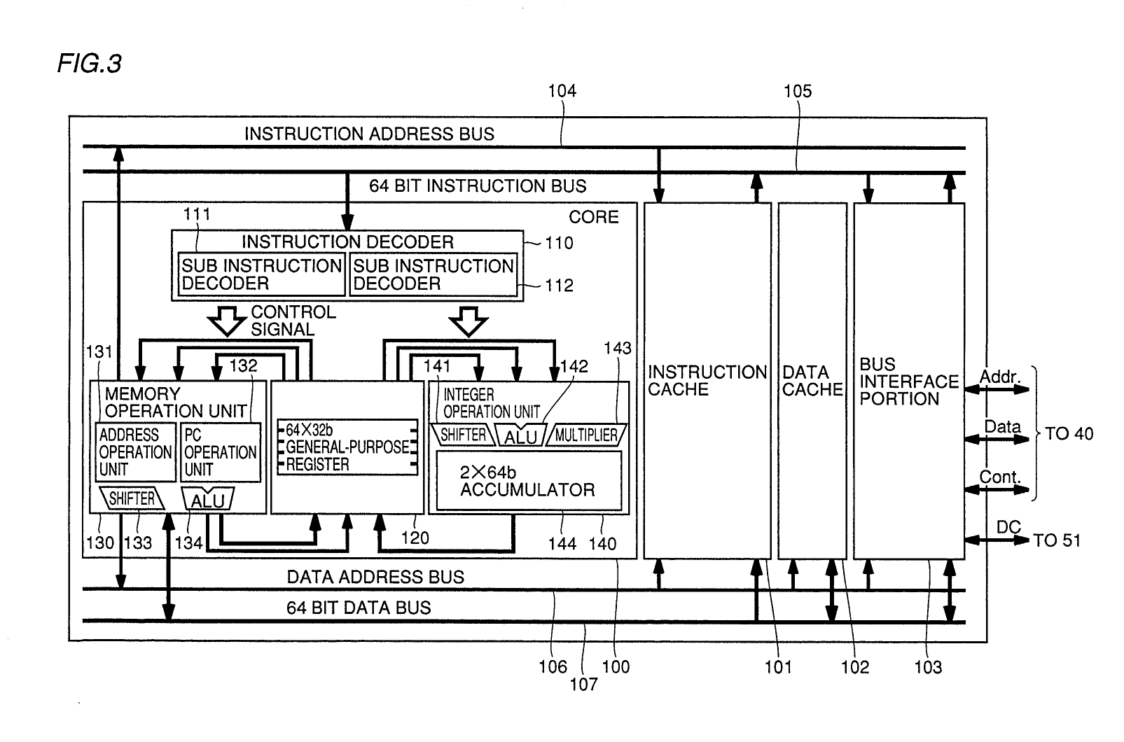

Referring to FIG. 3, processor 10 includes: a core 100; an instruction cache 101; a data cache 102; a bus interface portion 103 connected to bus 40 and DC signal 51; an instruction address bus 104 and an instruction bus 105 to interconnect them; a data address bus 106 and a data bus 107 each interconnecting core 100, instruction cache 101 and bus interface 103 for transmiting an address and data.

Core 100 is a processor having a VLIW (Very Long Instruction Word) type instruction architecture. Core 100 includes: an instruction decoder 110 for decoding a VLIW instruction received from instruction bus 105; a memory operation unit 130; and an integer operation unit 140 for executing an instruction decoded by instruction decoder 110; and a register file 120 connected to memory operation unit 130 and integer operation unit 140 with a plurality of buses.

Instruction decoder 110 includes two sub instruction decoders 111 and 112.

Memory operation unit 130 includes operation units such as an address operation unit 131, a PC operation unit 132, a shifter 133, and an ALU 134. Memory operation unit 130 executes a memory access instruction, a PC control instruction and an integer operation instruction according to the output of sub instruction decoder 111. Integer operation unit 140 includes a shifter 141, an ALU 142, a multiplier 143, and an accumulator 144. Integer operation unit 140 is used to execute an integer operation instruction according to the output of a sub instruction decoder 112. Memory operation unit 130 and integer operation unit 140 execute two sub instructions in parallel in some cases, and a single sub instruction independently in other cases.

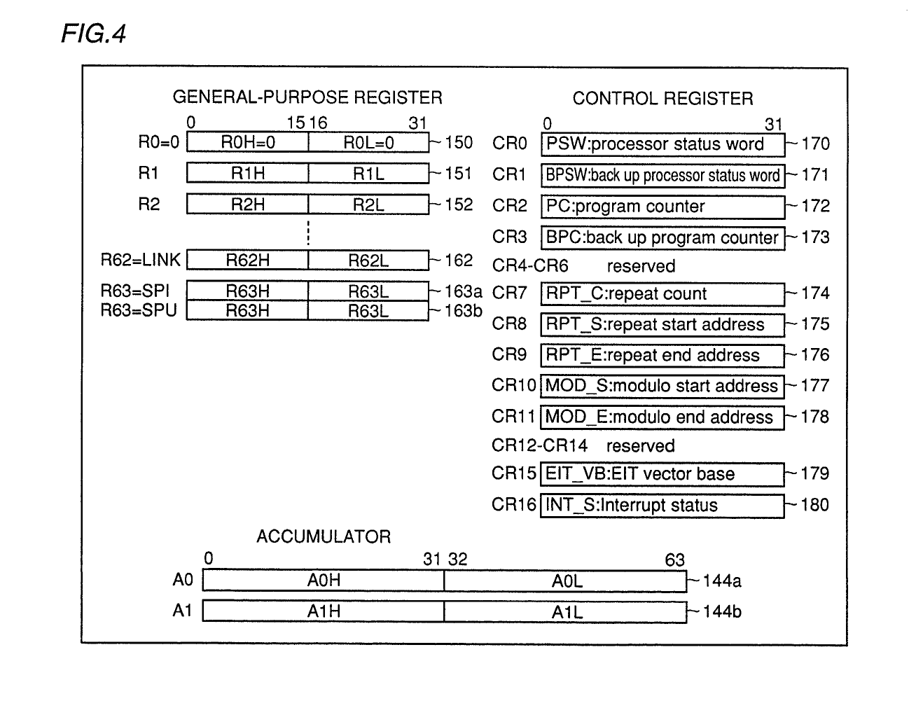

Referring to FIG. 4, register file 120 within processor 10 includes sixty-four general-purpose registers 150 to 152, 162, 163a and 163b. Processor 10 further includes control registers 170 to 180. Accumulator 144 includes accumulators 144a and 144b.

Register 150 is a register, which always holds zero. Register 162 is used to hold stack top data in the non-interrupt processing. Register 163b is a stack pointer in the non-interrupt processing and is used to hold the address of data immediately under the stack top. Registers 163a and 163b switch with a mode bit within control register 170, which is a PSW (Program Status Word). Register 163a is used in interrupt handling, and register 163b is used in a non-interrupt process.

Control registers 170 to 180 are registers each dedicated to a prescribed element. For example, control register 170 is a PSW, and holds flags which changes with operation, and a mode bit identifying the operational mode of processor 10 indicating whether it is in interrupt processing, interrupt masking, or whether or not in debug. Control register 172 is a program counter (PC), and represents the address of an instruction being executed at present. Control registers 171 and 173 are used to copy and hold the values of control registers 170 and 172, respectively, at the time of an interrupt, an exception, or a trap.

Accumulators 144a and 144b are used to hold a multiplication result, and a sum-of-product operation result. Accumulators 144a and 144b can each hold 64-bit data having a bit length as twice as large as that of a general-purpose register.

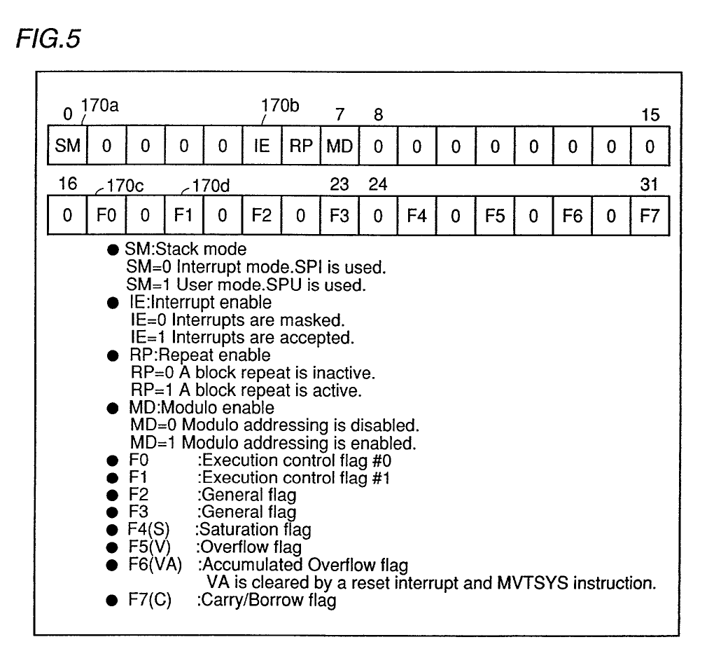

Referring to FIG. 5, the PSW held in control register 170 is 32-bit data, and includes: an SM bit 170a, which is a mode bit indicating whether in an interrupt or not; an IE bit 170b indicating whether in an interrupt allowed or prohibited; and F0 bit 170c and F1 bit 170d for controling the execution condition of an instruction. Control register 170 also includes an RP bit, an MD bit, and F2 to F7 bits. Their meanings are as given in FIG. 5.

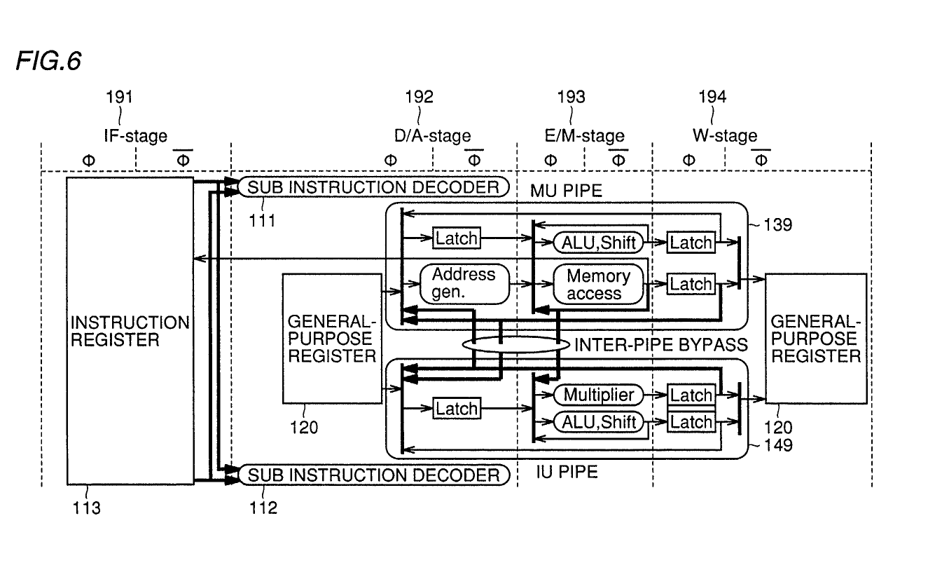

Referring to FIG. 6, processor 10 is pipelined to process an instruction as follows. Processor 10 includes an MU pipe 139 and an IU pipe 149 to execute sub instructions performed by memory operation unit 130 and integer operation unit 140, respectively. These pipes are each formed of an instruction fetch stage 191, a decode and address calculation stage 192, an operation and memory access stage 193 and a write back stage 194.

In instruction fetch stage 191, an instruction is fetched and held in instruction register 113 in instruction decoder 110. In decode and address calculation stage 192, the instruction is decoded by sub instruction decoders 111 and 112, register file 120 is accessed at the same time, and operand and PC address calculation is performed. In operation and memory access stage 193, an integer operation and a data memory access are performed. In write back stage 194, an operation result and data fetched from the memory are rewritten to register file 120.

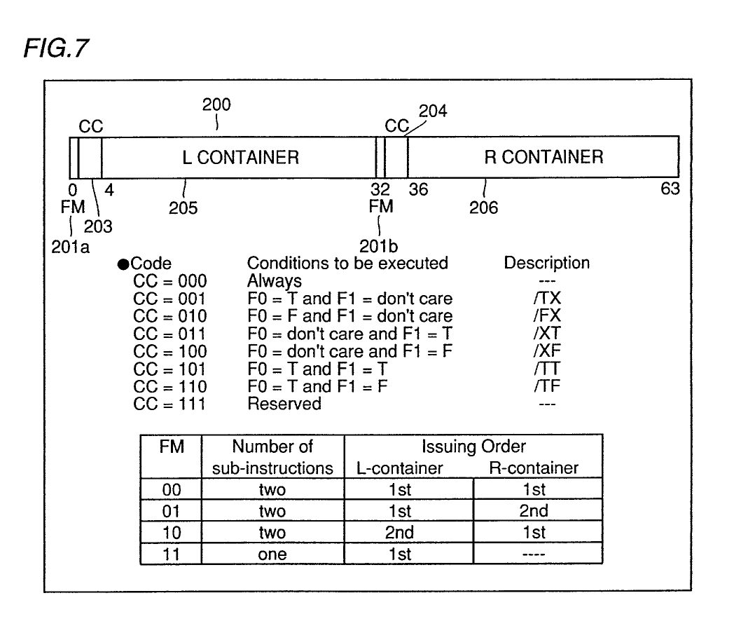

Referring to FIG. 7, an instruction 200 from processor 10 is a two-way VLIW type instruction, and has a format as shown in the figure. More specifically, instruction 200 includes: FM fields 201a, 201b for defining an execution order of sub instructions and for defining long sub instructions; an L container 205 and an R container 206 for storing sub instructions; and condition fields 203 and 204 for specifying the execution conditions of each sub instruction.

Condition fields 203 and 204 specify the conditions depending upon the values of flags F0 and F1 (F0 bit 170c and F1 bit 170d) in the PSW, which is control register 170. When condition field 203 is “000”, for example, the sub instruction included in L container 205 is executed unconditionally. When condition field 204 is “101”, the sub instruction included in R container 206 is executed if F0=1 and F1=1, and invalidated when flags F0 or F1 (F0 bit 170c or F1 bit 170d) assume another value.

FM fields 201a and 201b specify an execution operation when sub instructions included in L container 205 and R container 206 are to be executed. The execution operation includes four operations. The first operation executes the sub instructions included in L container 205 and R container 206 in parallel. The second operation executes the sub instruction in L container 205 first, and then the sub instruction in R container 206. The third operation, which is the opposite to the second operation, executes the sub instruction in R container 206 first and then the sub instruction in L container 205. The fourth operation executes a single long sub instruction, which is divided and held by L container 205 and R container 206. Thus, depending upon the values of FM fields 201a and 201b, any of the above four operations is selected.

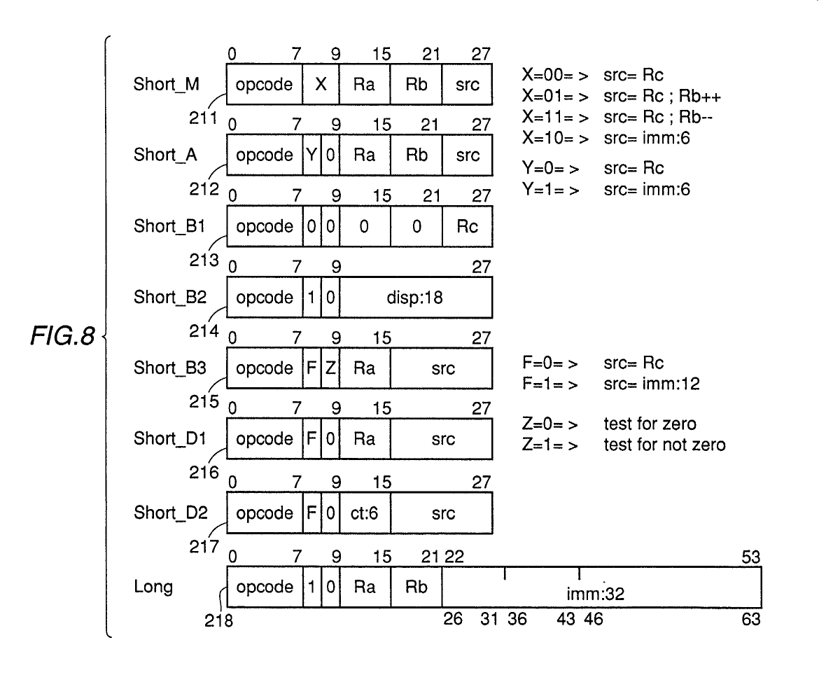

Referring to FIG. 8, the sub instructions that are held in L container 205 or R container 206 have the following format. The sub instructions are classified into 28-bit short instructions and 54-bit sub instructions. The short instructions have seven kinds of formats represented by formats 211 to 217. Briefly stated, the kind of the operation for the short instructions is identified at bit position 0-9, and three maximum operands are specified at bit position 10-27. The kind of operation for the long sub instructions is specified at bit position 0-9 as in format 218, and three maximum operands including immediate data having a 32-bit length are specified at bit position 10-53. Note that the 32-bit immediate value of the long sub instruction is held in VLIW instruction bit positions 26-31, 36-43 and 46-63.

Format 211 is for sub instructions for accessing a memory (load/store operations). Format 212 is for sub instructions to execute an operation upon operands (OP operation) held by general-purpose registers. Formats 213 to 217 are each for sub instructions for executing a branch instruction. The format 218 of the long sub instruction is used in common to the three kinds of operations described above.

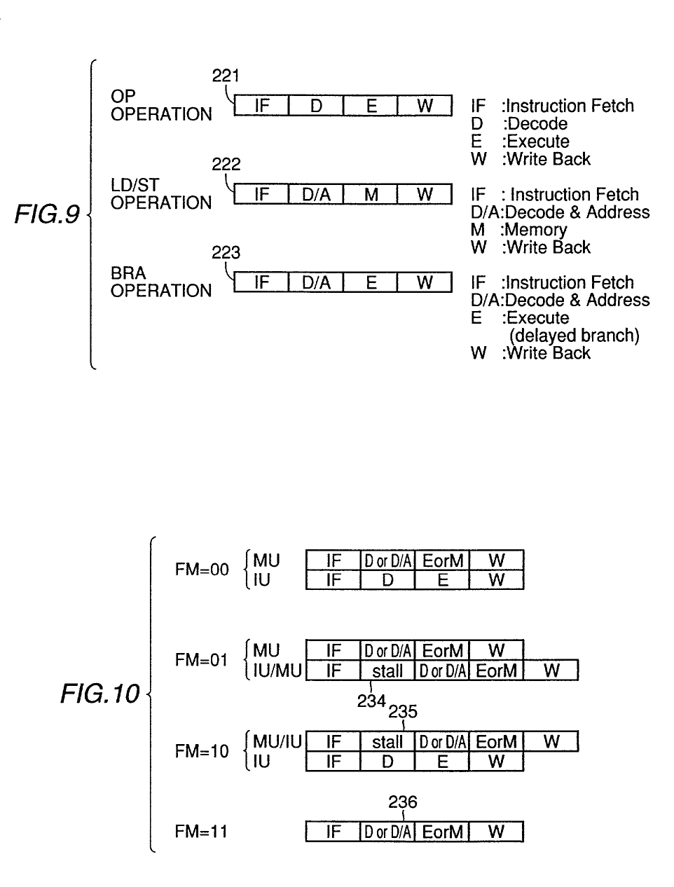

If a sub instruction is executed in a pipeline in processor 10 as shown in FIG. 6, sub instructions for the OP operation, load/store operation and branch operation are all executed in four pipeline stages denoted by 221 to 223, respectively as shown in FIG. 9.

When the order of executing the sub instructions is specified by FM fields 201a and 201b, the sub instructions are processed in a pipeline through MU pipe 139 and IU pipe 149 as shown in FIG. 10. Here, stall stages 234 to 236 are be inserted in order to delay execution of one of the sub instructions, when the sub instructions are indicated to be executed in a sequence by the values in FM fields 201a and 201b.

Next, a list of sub instructions defined for processor 10 is shown below. In the list, the mnemonic of each instruction is in capitals, and its content is given on the right side.

*Load/Store instructions

| | |
|---|---|
| LDB | Load one byte to a register with sign extension |
| LDBU | Load one byte to a register with zero extension |
| LDH | Load one half-word to a register with sign extension |
| LDHH | Load one half-word to a register high |
| LDHU | Load one half-word to a register with zero extension |
| LDW | Load one half-word to a register |
| LD2W | Load two words to registers |
| LD4BH | Load four bytes to four half-word registers with sign |
| | extension |
| LD4BHU | Load four bytes to four half-word registers with zero |
| | extension |
| LD2H | Load two half-words to registers |
| STB | Store one byte from a register |
| STH | Store one half-word from a register |
| STHH | Store one half-word from a register high |
| STW | Store one word from a register |
| ST2W | Store two words from registers |
| ST4HB | Store four bytes from four half-word registers |
| ST2H | Store two half-words from registers |
| MODDEC | Decrement a register value by a 5-bit immediate |
| | value |
| MODINC | Increment a register value by a 5-bit immediate |
| | value |

*Transfer instructions

| | |
|---|---|
| MVSYS | Move a control register to a general-purpose register |
| MVTSYC | Move a general-purpose register to a control register |
| MVFACC | Move a word from an accumulator |
| MVTACC | Move two general-purpose registers to an |
| | accumulator |
| CMPUcc | Compare unsigned |
| | cc = GT (010), GE (011), LT (100), LE (101) |
| | PS-both positive (110), NG-both negative (111) |

*Arithmetic operation instructions

| | |
|---|---|
| ABS | Absolute |
| ADD | Add |
| ADDC | Add with carry |
| ADDHppp | Add half-word |
| | ppp = LLL(000), LLH(001), LHL(010), LHH(011), |
| | HLL(100), HLH(101), HHL(110), HHH(111) |
| ADDS | Add register Rb with the sign of the third operand |
| ADDS2H | Add sign to two half-word |
| ADD2H | Add two pairs of half-words |
| AVG | Average with rounding towards positive infinity |
| AVG2H | Average two pairs of half-words rounding towards |
| | positive infinity |
| JOINpp | Join two half-words |
| | pp = LL(00), LH(01), HL(10), HH(11) |
| SUB | Subtract |
| SUBB | Subtract with borrow |
| SUBHppp | Subtract half-word |
| | ppp = LLL(000), LLH(001), LHL(010), LHH(011), |
| | HLL(100), HLH(101), HHL(110), HHH(111) |
| SUB2H | Subtract two pairs of half-words |

*Logical operation instructions

| | |
|---|---|
| AND | logical AND |
| OR | logical OR |
| NOT | logical NOT |
| XOR | logical exclusive OR |
| ANDFG | logical AND flags |
| ORFG | logical OR flags |
| NOTFG | logical NOT a flag |
| XORFG | logical exclusive OR flags |

*Shift operation instructions

| | | |
|---|---|---|
| SRA | Shift right arithmetic | |
| SRAHp | Shift right arithmetic a half-word | p = L (0), H (1) |
| SRA2H | Shift right arithmetic two half-words | |
| SRC | Shift right concatenated registers | |
| SRL | Shift right logical | |
| SRLHp | Shift right logical a half-word | p = L (0), H (1) |
| SRL2H | Shift right logical two half-words | |
| ROT | Rotate right | |
| ROT2H | Rotate right two half-words | |

*Bit operation instructions

| | |
|---|---|
| BCLR | Clear a bit |
| BNOT | Invert a bit |
| BSET | Set a bit |
| BRATZR | Branch if zero |
| BRATNZ | Branch if not zero |
| BSR | Branch to subroutine |
| BSRTZR | Branch to subroutine if zero |
| BSRTNZ | Branch to subroutine if not zero |
| DBRA | Delayed Branch |
| DBRAI | Delayed Branch immediate |
| DBSR | Delayed Branch to subroutine |
| DBSRI | Delayed Branch immediate to subroutine |
| DJMP | Delayed Jump |
| DJMPI | Delayed Jump immediate |
| DJSR | Delayed Jump to subroutine |
| DJSRI | Delayed Jump immediate to subroutine |
| JMP | Jump |
| JMPTZR | Jump if zero |
| JMPTNZ | Jump if not zero |
| JSR | Jump to subroutine |
| JSRTZR | Jump to subroutine if zero |
| JSRTNZ | Jump to subroutine if not zero |
| NOP | No operation |

*OS-related instructions

| | |
|---|---|
| TRAP | Trap |
| REIT | Return from exception, interrupts, and traps |

*DSP Arithmetic operation instructions

| | | |
|---|---|---|
| MUL | Multiply | |
| MULX | Multiply with extended precision | |
| MULXS | Multiply and shift to the left by one | |
| | with extended precision | |
| MULXS2H | Multiply two pairs of half-words with | |
| | extended precision | |
| MULHXpp | Multiply two half-words with | |
| | extended precision | |
| | pp = LL(00), LH(01), HL(10), | |
| | HH(11) | |
| MUL2H | Multiply two pairs of half-words | |
| MACd | Multiply and add | (d = 0, 1) |
| MACSd | Multiply, shift to the left by one, | (d = 0, 1) |
| | and add | |
| MSUBd | Multiply and subtract | (d = 0, 1) |
| MSUBSd | Multiply, shift to the left by one, | (d = 0, 1) |
| | and subtract | |

| | |
|---|---|
| SAT | Saturate |
| SATHH | Saturate word operand into high half-word |
| SATHL | Saturate word operand into low half-word |
| SATZ | Saturate into positive number |
| SATZ2H | Saturate two half-words into positive number |
| SAT2H | Saturate two half-word operands |

*Repeat instructions

| | |
|---|---|
| REPEAT | Repeat a block of instructions |
| REPEAT1 | Repeat a block of instructions with immediate |

*Debugger supporting instructions

| | |
|---|---|
| DBT | Debug trap |
| RTD | Return from debug interrupt and trap |

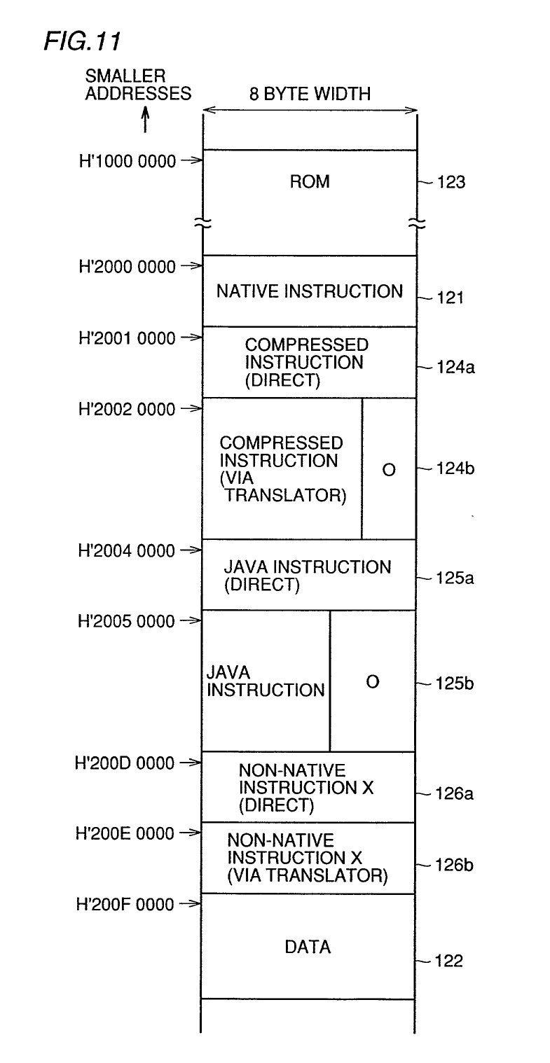

FIG. 11 shows an address map used by processor 10 shown in FIG. 2 when processor 10 accesses RAM21 for native instruction, data memory 22, ROM 23, memory 24 with a translator for compressed instruction, memory 25 with a translator for JAVA instruction, and memory 26 with a translator for non-native instruction X, all through bus 40. As shown in FIG. 11, RAM 21 for native instruction, data memory 22 and ROM 23 are mapped to an address region 121 for native instruction, an address region 122 for data memory, and an address region 123 for ROM, respectively. Memory 24 with a translator for compressed instruction, memory 25 with a translator for JAVA instruction, and memory 26 with a translator for non-native instruction X are mapped to an address region 124a for compressed instruction (direct), an address region 125a for JAVA instruction (direct), and an address region 126a for non-native instruction X (direct) when read/write is performed without translation of instruction codes. Memory 24 with a translator for compressed instruction, memory 25 with a translator for JAVA instruction, and memory 26 with a translator for non-native instruction X are mapped to region 124b for compressed instruction (via translator), an address region 125b for JAVA instruction (via translator), and an address region 126b, respectively.

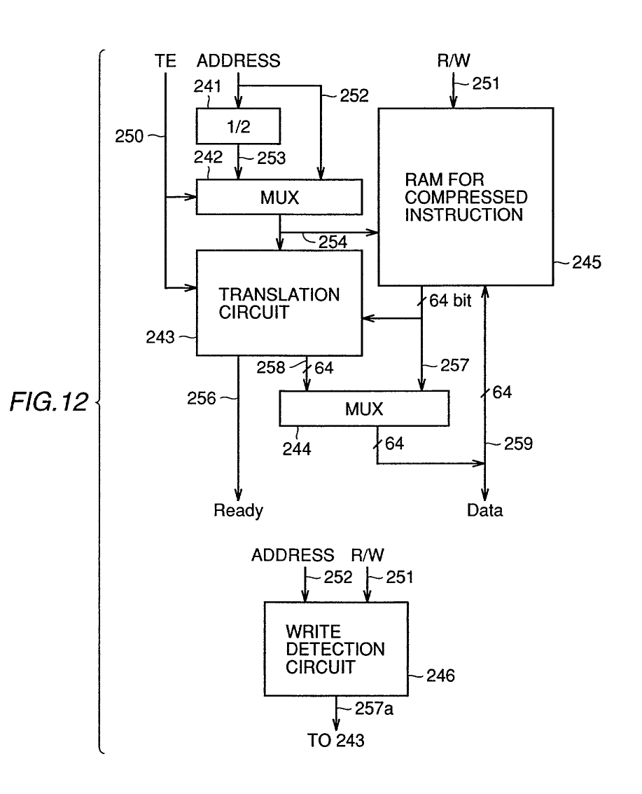

Referring to FIG. 12, memory 24 with a translator includes a translator 14 and a RAM 245 for compressed instruction. Translator 14 includes: a translation circuit 243;, an address translator 241 for shifting an input value to the right by 1 bit to divide the value by 2 and for outputting the result as ½ the value onto an address line 253; an MUX 242 for selecting the divided address by selecting address line 253 if translation function enable signal TE on TE signal line 250 indicates expansion of the instruction and otherwise for selecting a value on an address line 252, and for applying the selected address to RAM 245 for compressed instruction and translation circuit 243; a WRITE detecting circuit 246 for outputting a control signal 257a indicating invalidation of an entry in a cache memory in translation circuit 243 corresponding to an address on address line 252, when a writing is made to RAM 245 for compressed instruction, and applying the output signal to translation circuit 243, based on the address on address line 252 and an R/W signal 251 that indicates a WRITE of an instruction from data line 259 to RAM 245 for compressed instruction or a READ of an instruction therefrom.

When control signal 257a is asserted, translation circuit 243 looks at an address on address line 254 at that time and invalidates a corresponding entry in the cache. Thus, an old translation result based on an outdated contents of RAM 245 for compressed instruction can be prevented from being read out from the cache. Additionally, address translator 241 changes an access address to memory 24 with a translator for compressed instruction.

Memory 24 with a translator for compressed instruction further includes an MUX 244 for, when an instruction code is to be read out of memory 24, either outputting the instruction code output through instruction code output line 257 from RAM 245 to data line 259 as it is, or expanding it at translation circuit 243 and output the expanded instruction code to data line 259 from a post-expansion instruction code output line 258. Translation circuit 243 also outputs a READY signal, which is a tri-state signal, onto a READY signal line 256 in order to specify the timing to output the expanded instruction code onto READY signal line 50 coupled to bus control circuit 20.

From the viewpoint of processor 10, the address of memory 24 with a translator for compressed instruction is formed of address region 124a for compressed instruction (direct) and an instruction region 124b for compressed instruction (via translator). When memory 24 with a translator for compressed instruction is accessed at address region 124a for compressed instruction (direct), an effective memory is present at all the byte positions in the space of 64 KB. Meanwhile, when memory 24 with a translator for compressed instruction is accessed at address region 124b for compressed instruction (via translator), an effective memory is present in the respective most significant 4 bytes of 8 bytes each aligned in the space of 128 KB, but there is no effective memory in the respective least significant 4 bytes. The reason is that memory 24 with a translator compresses the two sub instructions in the 8-byte VLIW instruction each into two byte data and stores them without changing their addresses. If processor 10 executes a compressed VLIW instruction fetched from address H'20020100, for example, two 2-byte instructions are expanded into one 8-byte VLIW instruction and outputted from memory 24 with a translator for compressed instruction, and processor 10 increments the PC value by 8 bytes and fetches the next instruction from address H'20020108 and executed it.

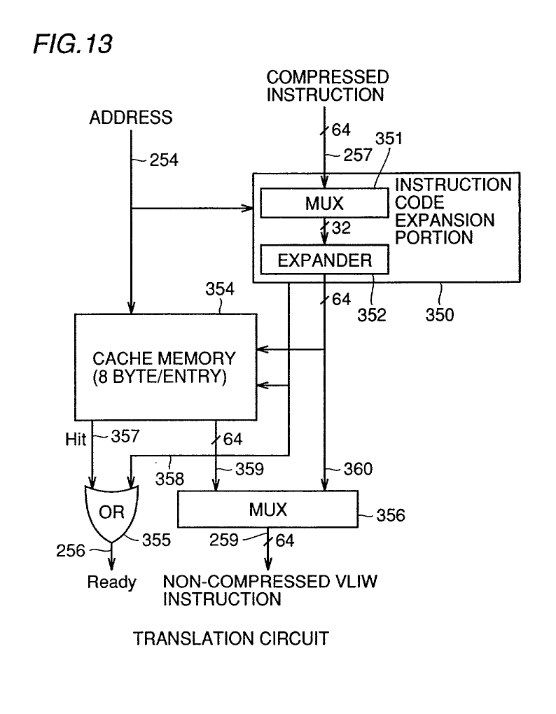

Referring to FIG. 13, translation circuit 243 includes: a cache memory 354 which outputs an expanded VLIW instruction onto an output line 359 and asserts a cache hit signal on cache hit signal line 357 as well if it holds an expanded instruction corresponding an address applied from address line 254; an instruction code expansion portion 350, which expands two instructions input from instruction code output line 257 into an 8-byte VLIW instruction, outputs it onto an output line 360, and outputs a signal indicating a timing of the end of expansion of the instruction; an MUX 356, which selects either one of output line 359 from cache memory 354 or output line 360 from instruction code expansion portion 350 and outputs the selected signal; and an OR circuit 355, which outputs the logical sum of cache hit signal line 357 from cache memory 354 and a timing signal line 358 from instruction code expansion portion 350. Instruction code expansion portion 350 includes: an MUX 351, which selectively outputs one of two compressed instructions input from instruction code output line 257, and an expander 457 to expand an instruction output from MUX 351.

An address input from address line 254 is input to cache memory 354 and instruction expansion portion 350. Cache memory 354 is a 2-way set associative cache, one entry of which has a capacity of 2 KB, as will be described in the following. Cache memory 354 checks whether or not an instruction of the same address as that of the input address has been expanded in the past and held therein, and if such an instruction is determined to be held, an expanded VLIW instruction is output to output line 359, and a cache hit signal on cache hit signal line 357 is asserted, which indicates that cache memory 354 has a cache hit. The cache hit signal asserts the READY signal on READY signal line 256 via OR circuit 355. At this time, MUX 356 selects the output on output line 359 and outputs the expanded VLIW instruction output from cache memory onto data line 259.

Meanwhile, when cache memory 354 has a miss, an expanded 8-byte VLIW instruction output from instruction code expansion portion 350 to output line 360 is selected by MUX 356, and output to data line 259. At this time, the expanded instruction code output onto data line 259 is transferred to cache memory 354 as well, and written into a corresponding entry. When the expansion of the instruction has completed in expander 352, a timing signal on timing signal line 358 is asserted. The timing signal asserts the READY signal on READY signal line 256 via an OR circuit 355.

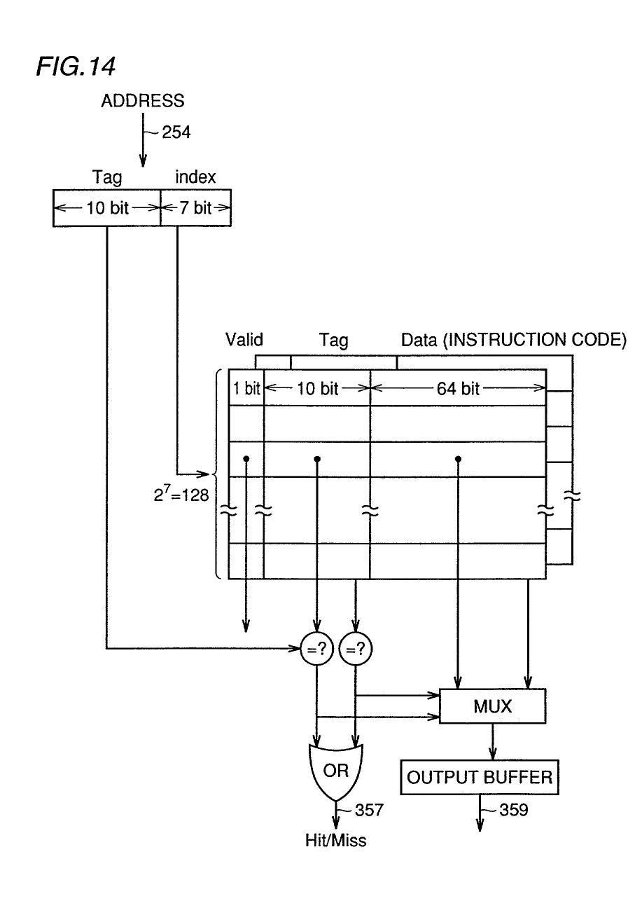

FIG. 14 shows cache memory 357 in detail. As shown in FIG. 14, cache memory 354 is a 2-way set associative cache, which searches for a tag and an instruction code held by each way using the least significant 7 bits of address line 254 as an index, and determines if there is a matching tag. If there is a matching tag, a match signal is output from the way. The match signal is output via the OR circuit to cache hit signal line 357 to drive a cache hit signal. Meanwhile, a corresponding instruction code (64 bits) is output from an entry indicated by the index of address line 254, and one of them is selected based on the match signal and output to output line 359 via an output buffer.

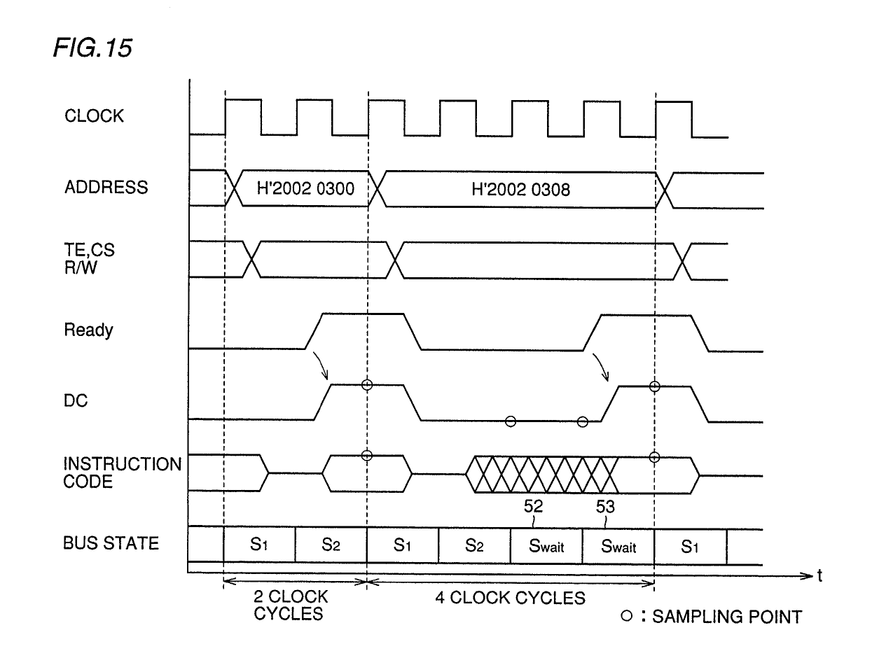

FIG. 15 is a timing chart for use in illustration of signal change in bus 40, READY signal line 50 and DC signal 51 when processor 10 accesses memory 24 with a translator for compressed instruction to fetch an instruction. Referring to FIG. 15, when cache memory 354 has hit, the READY signal on READY signal line 50 is asserted one clock after the start of a bus cycle, and the end of the bus cycle is signaled to processor 10 by DC signal 51 from bus control circuit 20 two clocks after the start of the bus cycle. The instruction code of the expanded VLIW instruction held by cache memory 354 is output to bus 40 via data line 259 from memory 24 with a translator for compressed instruction one and a half clocks after the start of the bus cycle, and accepted to processor 10 two clocks after the start of the same bus cycle as the sampling timing of DC signal 51.

Meanwhile, if cache memory 354 has a miss, READY signal line 50 is once negated one clock after the start of the bus cycle, and asserted three clocks after the start of the bus cycle. Thus, two and three clocks after the start of the bus cycle, processor 10 is informed by DC signal 51 of insertion of wait cycles 52 and 53 in the bus cycle from bus control circuit 20. Four clocks after the start of the bus cycle, the end of the bus cycle is signaled to processor 10 by DC signal 51 from bus control circuit 20. The instruction code of the VLIW instruction expanded by instruction code expansion portion 350 is output to bus 40 via data line 259 from memory 24 with a translator for compressed instruction three and a half clocks after the start of the bus cycle, and accepted to processor 10 four clocks after the start of the same bus cycle in the sampling timing of DC signal 51.

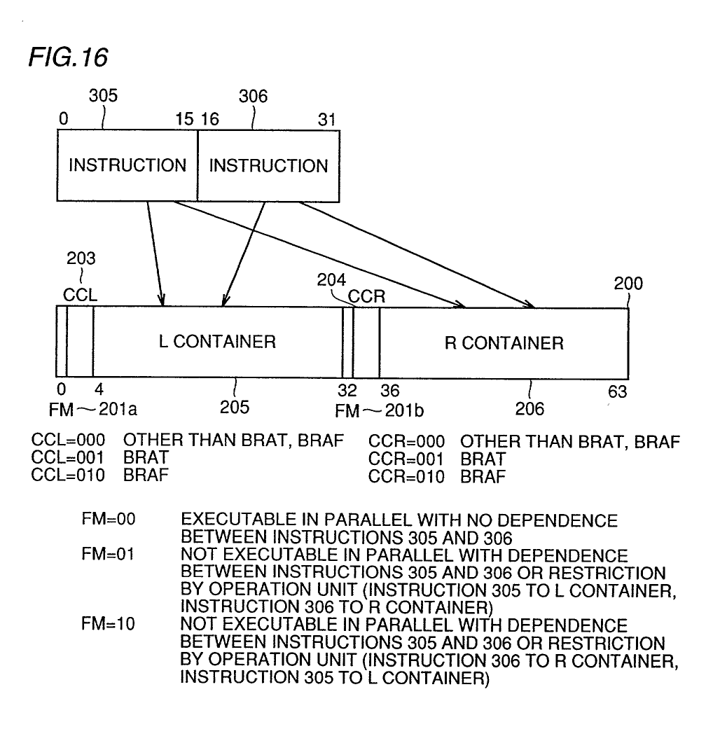

FIG. 16 shows how two compressed instructions 305 and 306 placed on one four-byte boundary correspond to one and the other fields of a sub instruction of the expanded VLIW instruction. Referring to FIG. 16, with respect to the order of executing the compressed instructions 305 and 306, instruction 305 is logically executed first based on the address position, and then instruction 306 is executed. Expander 352 generates a sub instruction, corresponding to instruction 305, to be executed by processor 10 in the field of L container 205 or R container 206, and a sub instruction corresponding to the remaining container 306. More specifically, one instruction is generated from two instructions. FM fields 201a and 201b will be “00” if there is no dependency between the operands of instructions 305 and 306 and if the two instructions can be executed by processor 10 in parallel. If the dependency between the operands exists or such parallel execution is not possible from the hardware constraint of processor 10, FM fields 201a and 201b will be “10” if an instruction corresponding to instruction 305 is placed in L container 205 and “01” if the instruction is placed in R container 206.

Condition fields 203 and 204 will be “000”, “001” or “010” based on whether instructions 305 and 306 are a condition branch instruction BRAT or BRAF or an instruction other than these.

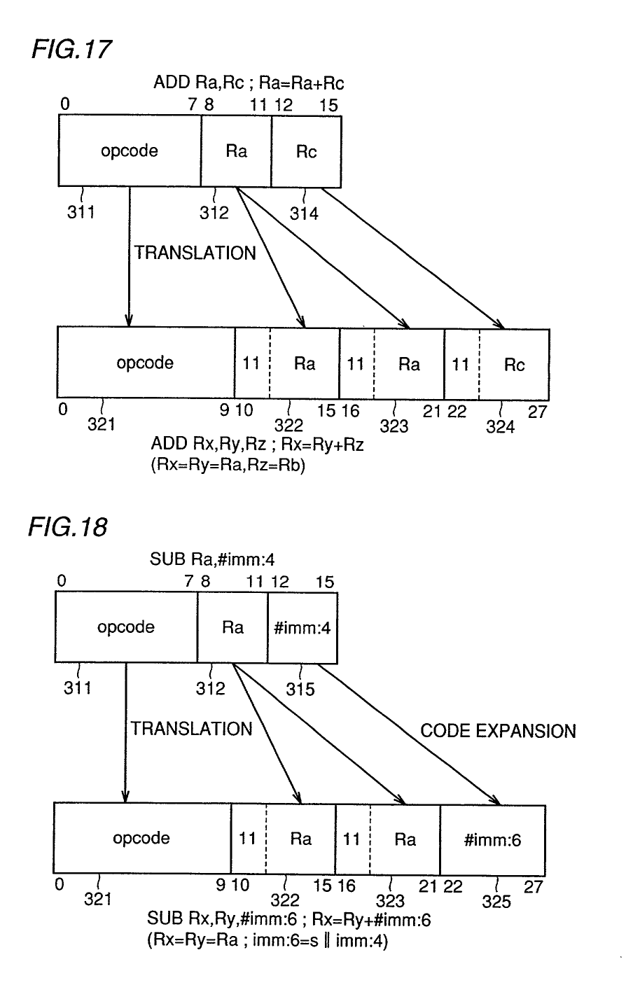

FIGS. 17 to 20 show examples of how a compressed instruction corresponds to an instruction bit pattern when it is expanded into a sub instruction. Instruction “Add Ra, Rc” in FIG. 17 is extended into a sub instruction “ADD, Rx, Ry, Rz”. A 9-bit OP code 311 is translated into a 9-bit different OP code 321. A 4-bit register number Ra312 is translated into register numbers Rx322 and Ry323 with “11” added to its most significant two bit positions. Similarly, a 4-bit register number Rc314 is translated to a register number Rz324.

Referring to FIG. 18, an instruction “SUB Ra, #imm:4” is expanded into a sub instruction “SUB Rx, Ry, #imm:6”. OP code 311 and register number Ra312 are translated in the same manner as that shown in FIG. 17. A 4-bit literal 315 is translated into a 6-bit literal 325 with sign-extended.

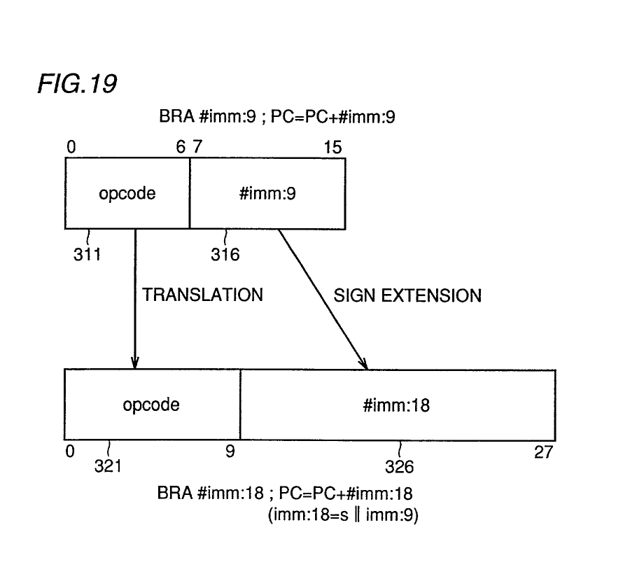

Referring to FIG. 19, an instruction “BRA #imm:9” is expanded into a sub instruction “BRA#imm:18”. OP code 311 is translated to OP code 321, and a 9-bit displacement is translated into a 18-bit displacement 326 with sign-extension.

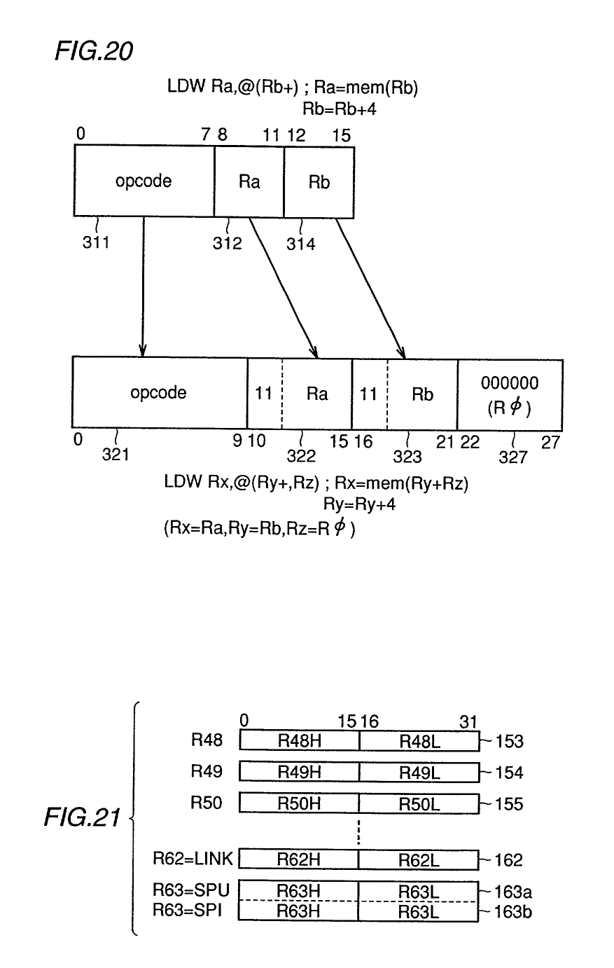

Referring to FIG. 20, an instruction “LDW Ra, @(Rb+)” is extended into a sub instruction “LDW Rx, @(Ry+, R0)”. OP code 311 is transformed to OP code 321, and register number Ra312 is translated to a register number RX with “11” added at its most significant bit positions. Register number Rb314 is translated to a register number Ry with “11” added at its most significant bit positions. The register number 327 of the sub instruction is the number “000000” representing R0.

As described above, while a sub instruction basically has three operands, a compressed instruction basically two operands. The sub instruction can specify 64 general-purpose registers with a 6-bit field as an operand, but the compressed instruction can only specify 16 general-purpose registers with a 4-bit field as an operand. At the time of translation, “11” is added at the most significant bit position to expand a register number, and therefore, as shown in FIG. 21, general-purpose registers which can be specified as an operand in the compressed instruction correspond to general-purpose registers R48 to 63 (153 to 155, 162, 163a, 163b) for the sub instruction.

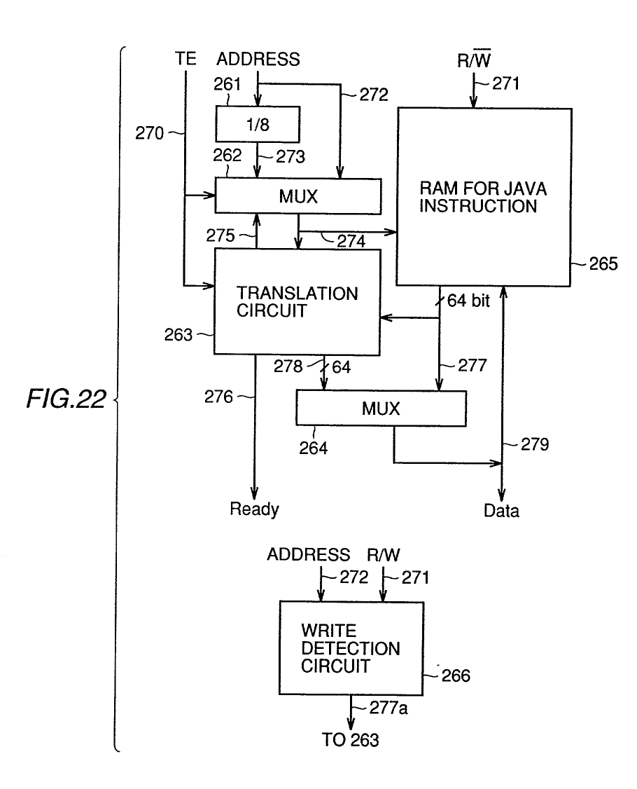

Referring to FIG. 22, memory 25 with a translator for JAVA instruction includes a translator 15 and a RAM 265 for JAVA instruction.

Translator 15 includes: a translation circuit 263 for JAVA instruction; a shift circuit 261, which shifts an address applied from address line 272 by 3 bits to the right, thus dividing the address by eight, and outputs it to address line 273; an MUX 262, which selects one of address lines 273 and 272 based on the value of translation function enable TE on translation function control signal line 270, and applies the selected one to translation circuit 263 for JAVA instruction and RAM 265 for JAVA instruction through address line 274; an MUX 264, which selects one of output lines 277 and 278 and outputs the selected one to data line 279; and a write detection circuit 266, which detects the presence of a write to RAM 265 for JAVA instruction and outputs a control signal instructing invalidation of all the entries in the cache memory in translation circuit 263 for JAVA instruction on control signal line 277a.

MUX 262 selects address line 273 and applies an address whose value is divided by eight to RAM 265 for JAVA instruction and translation circuit 263 for JAVA instruction through address line 274, if translation function enable signal TE indicates an instruction translation. MUX 262 outputs an address applied through address line 275 from translation circuit 263 for JAVA instruction to the address line 274, when translation circuit 263 for JAVA instruction access RAM 265 for JAVA instruction for the second time and on in order to translate the instruction code.

MUX 264 controls whether to output the signal on output line 277 from RAM 265 for JAVA instruction directly to data line 279 or to output an instruction code (which has been translated by translation circuit 263 for JAVA instruction) applied through output line 278, if the instruction code is read out from memory 25 with a translator for JAVA instruction.

The READY signal on READY signal line 276 indicates when an instruction after translation is to be output from translation circuit 263 for JAVA instruction. READY signal is a tristate output signal transmitted to READY signal line 50, and further applied to bus control circuit 20.

An R/W signal on an R/W signal line 271 applied to write detection circuit 266 specifies whether to write or read an instruction code to or from data line 279 to RAM 265 for JAVA instruction. If there is a write to RAM 265 for JAVA instruction, write detection circuit 266 detects it and outputs a control signal to control signal line 277a. When the control signal is asserted, translation circuit 263 invalidates all the cache entries. By this operation, an outdated translation result based on the outdated content of RAM 265 for JAVA instruction can be prevented from being read out from the cache.

To processor 10, the address of memory 25 with a translator for JAVA instruction appears to include an address region 125a for JAVA instruction (direct) and an address region 125b for JAVA instruction (via translator) shown in FIG. 11. When memory 25 with a translator is accessed at address region 125a for JAVA instruction (direct), there are valid memories at all the byte positions in the space of 64 KB. Meanwhile, if memory 25 with a translator for JAVA instruction is accessed at address region 125b for JAVA instruction (via translator), there are valid memories at the most significant 1 byte of 8 bytes each aligned in the space of 512 KB, but no memory exists for the less significant 7 bytes.

When processor 10 fetches and executes a compressed VLIW instruction from address H'20050300, for example, memory 25 with a translator for JAVA instruction outputs JAVA instruction expanded into one or a plurality of 8-byte VLIW instructions, processor 10 executes the one or plurality of VLIW instructions by incrementing the PC value by 8 bytes for each byte of the JAVA instruction.

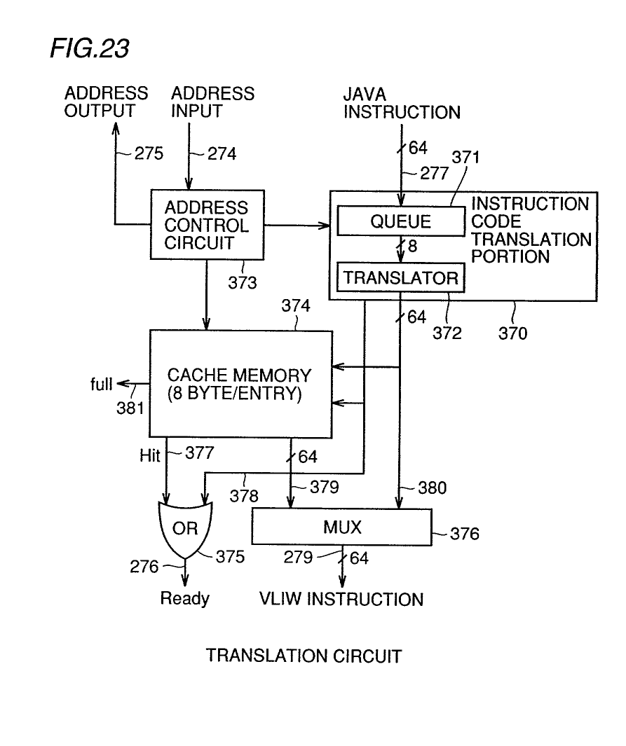

Referring to FIG. 23, translation circuit 263 for JAVA instruction includes an instruction code translation portion 370; a cache memory 374; an address control circuit 373, which applies an address input from address line 274 to instruction code translation portion 370 and cache memory 374 and further outputs it to address line 275; an MUX 376, which receives the output lines 379 and 380 of cache memory 374 and instruction translation portion 370, respectively, and selects one of instruction codes applied from them for output to data line 279; and an OR circuit 375 receiving a hit signal applied through a cache hit signal line 377 from cache memory 374, a timing signal indicating the end of expansion applied through a signal line 378 from instruction code translation portion 370 and having its output connected to READY signal line 276. Instruction code translation portion 370 includes a queue 371 and a translator 372.

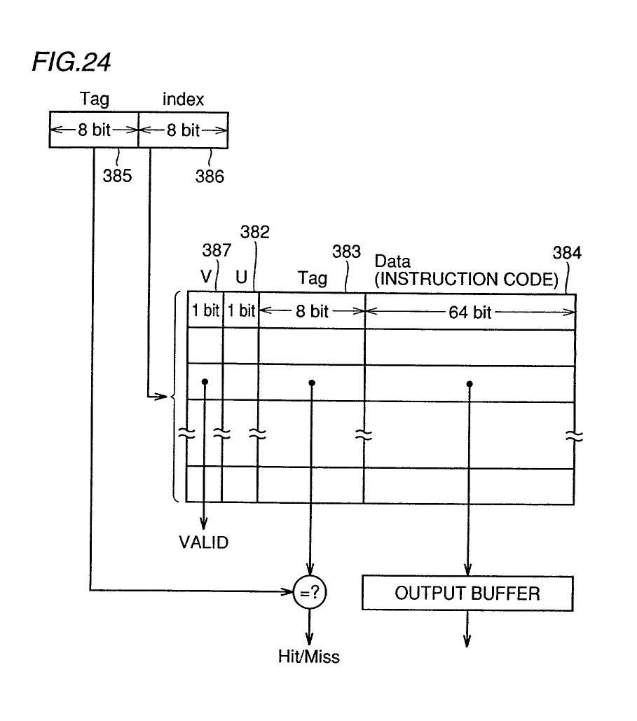

Referring to FIG. 24, cache memory 374 is a direct map cache having a capacity of 2 KB with 8 bytes per one entry. Each entry of cache memory 354 includes two valid bits, V bit 387 and U bit 382, the tag 383 of an address to be compared, and data 384 as an instruction code.

Referring to FIG. 22, a 19-bit address indicating one of H'20050000 to H'200CFFFF applied from address line 272 is shifted by 3 bits to the right and divided by eight, the valid 16 bits of which are applied to translation circuit 263 for JAVA instruction and instruction code translation portion 370 through address line 274 and address control circuit 373.

Referring to FIG. 24, in cache memory 374, the address is divided into a tag 385 of the more significant 8 bit and an index 386 of the less significant 8 bits. Index 386 is used to elect an entry. Tag 385 is used for comparison with tag 383 read out from each entry. If V bit 387 indicates valid, and there are entries having the same values for tag 383 and tag 385, it is a cache hit, which asserts a hit signal. Meanwhile, the data 384 of the entry is output to output line 379 as an instruction code. The cache hit signal output onto cache hit signal line 377 shown in FIG. 23 asserts the READY signal on READY signal line 276 via OR circuit 375.

Referring back to FIG. 23, in instruction code translation portion 370, queue 371 once lets a JAVA instruction into the queue, and then the JAVA instruction is read out on a 1-byte basis and translated into a VLIW instruction for output to the output line 380 of instruction code translation portion 370. The processing clock number of translator 372 changes depending upon the length and kind of the JAVA instruction and on the number and kind of the VLIW instruction after the translation.

If the cache hit signal on cache hit signal line 377 is asserted, MUX 376 selects output line 379 and outputs the VLIW instruction after the translation onto data line 279. Meanwhile, if the cache hit signal is not asserted, in other words, if a miss occurs in cache memory 374, MUX 376 selects an 8-byte VLIW instruction after the translation which instruction code translation portion 370 has output onto the output line 380 of instruction code translation portion 370 for output to data line 279. At this time, the VLIW instruction on the output line 380 of instruction code translation portion 370 is also transferred to cache memory 374, and written into a corresponding entry. A timing signal on signal line 378 is asserted when the translation ends and the VLIW instruction is output onto the output line 380 of instruction code translation portion 370, and the timing signal asserts the READY signal on READY signal line 276 via OR circuit 375.

Note that when the JAVA instruction is translated into a plurality of VLIW instructions, instruction code translation portion 370 stores all the VLIW instructions after the translation, regardless of access from processor 10.

The JAVA instruction has a instruction length variable on a byte basis and can be placed at any address on the memory. It should be therefore noted that if a JAVA instruction of 2 or more bytes is read out from the memory, RAM 265 for JAVA instruction must be accessed twice or more depending upon the address position of the JAVA instruction.

For example, assume that a 2-byte JAVA instruction J2 is at address (8n+7), which is the last address at the 8-byte boundary. At this time, in RAM 265 for JAVA instruction, the last one byte of J2 must be read out from address (8n+7) by the first access, and the next one byte of J2 must be read out from address 8n+8 by the second access. Address 8n+8 for the second access is output from translation circuit 263 for JAVA instruction onto address line 275.

As described above, the VLIW instruction translated by translator 372 is stored on a one-by-one basis in cache memory 374 via the output line 380 of instruction code translation portion 370. If one JAVA instruction is translated into a plurality of VLIW instructions and stored in cache memory 374, the plurality of VLIW instruction should be always arranged in sets and held by cache memory 374. To this end, in an entry other than the head VLIW instruction, U bit 382 is set to “1”. Thus, the entry including U bit 382 set to “1” can be prevented from being invalidated without the involvement of software in cache memory 374 or from being removed from cache memory 374. If one JAVA instruction is translated into a plurality of VLIW instructions and the plurality of VLIW instructions are stored in cache memory 374, a VLIW instruction other than the head VLIW instruction may not be stored if the cache is fully loaded. In this case, a FULL signal 381 is asserted, and in response to the asserted signal, an entry including the head VLIW instruction is invalidated by software control.

This is done for the following reasons. Assume that one JAVA instruction is translated into a plurality of VLIW instructions. Then, an interrupt request may be generated and handled between one VLIW instruction (instruction A) and another VLIW instruction (instruction B). After handling the interrupt, execution of the program will be resumed from VLIW instruction B. However, if the instruction B is not stored in the cache memory any more, translation will be started in the middle of one JAVA instruction, causing a false translation. Instructions, including the JAVA instruction, executed by processors in general have immediate data in a byte inbetween, and therefore cannot be correctly recognized unless the head byte is observed first. U bits 382 are provided to prevent such a false translation from occurring. Note that if FULL signal 381 is asserted and there is such entries which can be safely invalidated because U bit 382 is “1” by software control but corresponding head VLIW instruction is not present in the cache, these entries can be invalidated to increase vacant entries in cache memory 374, and the VLIW instruction which has caused FULL signal to be asserted may be stored in cache memory 374.

If an entry is invalidated in the same manner as the conventional cache memory, or an entry is removed for new registration in cache memory 374, an instruction translation could start to be executed in the middle of one JAVA instruction by translator 372 even if there is no interrupt. To prevent this, each entry of cache memory 374 is provided with U bit 382 in the apparatus according to the embodiment. When a plurality of VLIW instructions, which are translated from one JAVA instruction, at consecutive addresses are stored in cache memory 374, at entries corresponding to VLIW instructions other than the head VLIW instruction, U bit 382 is set to “1”. An entry whose U bit 382 is “1” will not be invalidated or removed from cache memory 374 without operation by software. As described above, the invalidation or removal of an entry whose U bit 382 is “1” are possible only when the head VLIW instruction of the plurality of VLIW instructions translated from the JAVA instruction together with the VLIW instruction included in the entry is not present in cache memory 374. This is controlled by software.

Thus, translator 372 is prevented from starting translation from the middle of the JAVA instruction as the head VLIW instruction of the plurality of VLIW instructions translated from one JAVA instruction is registered in cache memory 374, while succeeding VLIW instructions are not stored in cache memory 374.

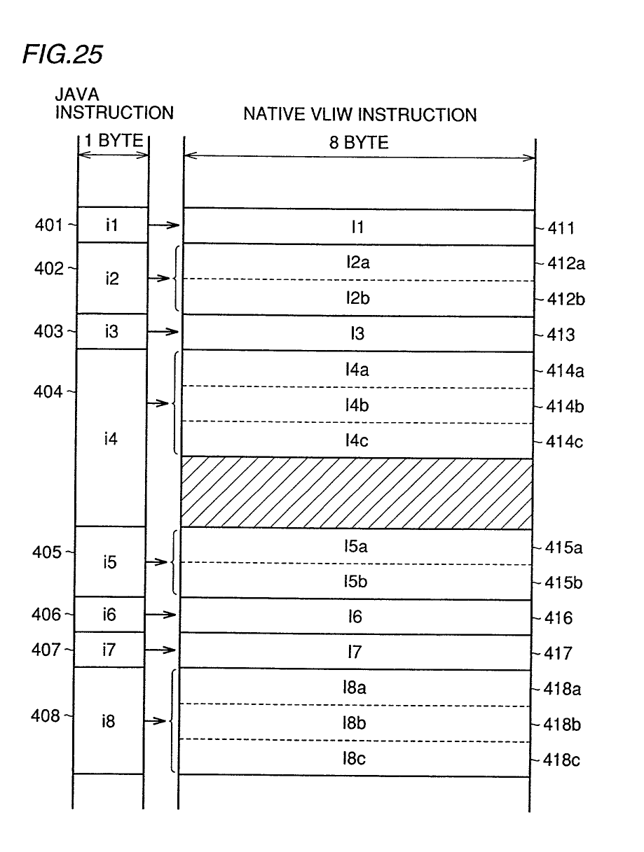

Referring to FIG. 25, the relationship between the JAVA instruction to be translated by instruction code translation portion 370 and the VLIW instruction is as follows. For example, a 1 byte-JAVA instruction 401 is translated to an 8-byte VLIW instruction 411. Since JAVA instruction 401 is 1-byte length, it can be read out by a single access to RAM 265 for JAVA instruction. VLIW instruction 411 after the translation positioned at a 8-byte boundary is stored in one entry in cache memory 374.

A 2-byte JAVA instruction 402 is translated to two 8-byte VLIW instructions 412a and 412b. At this time, in an entry including VLIW instruction 412b, U bit 382 is “1”.

A 5-byte JAVA instruction 404 is translated into three 8-byte VLIW instructions 414a, 414b and 414c. In entries including VLIW instructions 414b and 414c, U bit 382 is both “1”.

Similarly, JAVA instruction 403, JAVA instruction 406, and JAVA instruction 407 are translated to VLIW instructions 413, 416 and 417, respectively, and JAVA instruction 408 is translated to three 8-byte VLIW instructions 418a to 418c, respectively. In entries including VLIW instructions 418b and 418c, U bit 382 is both “1”.

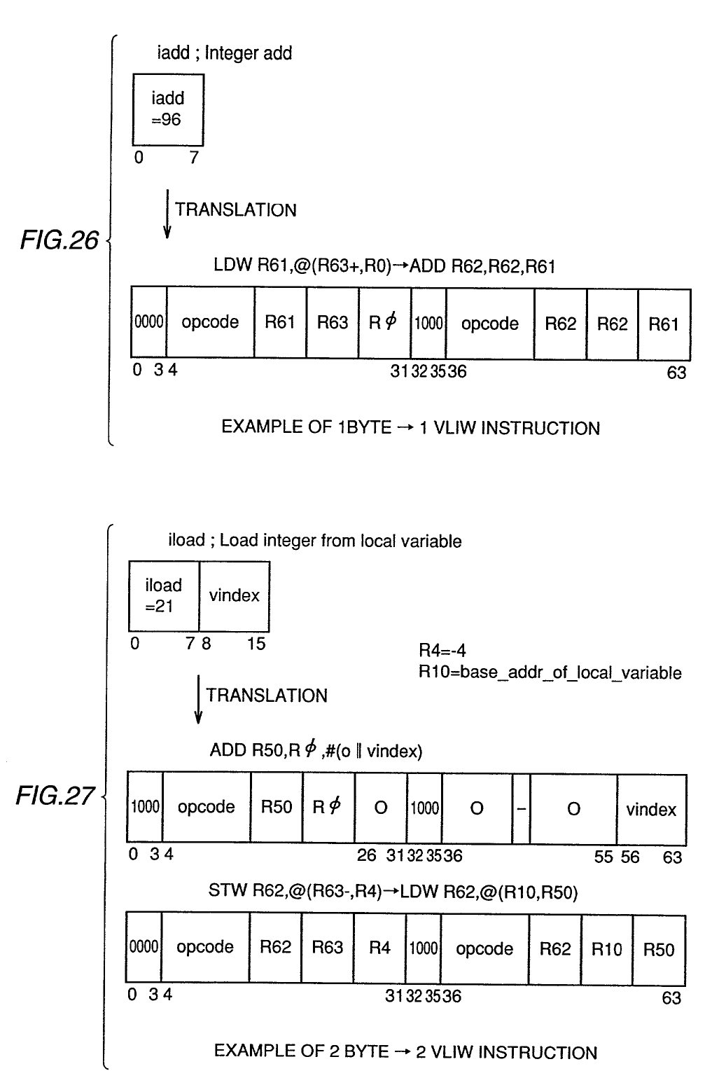

FIGS. 26 to 31 show specific examples of how a JAVA instruction is translated to a VLIW instruction by translator 372. Referring to FIG. 26, a 1-byte JAVA instruction “iadd” is translated to one VLIW instruction which sequentially executes a sub instruction “LDW R61, @(R63+, R0)” and a sub instruction “ADD R62, R62, R61”. Instruction “iadd” is a JAVA instruction to add first and second data from the stack top which are two 32-bit integers and write the result again to the stack. In processor 10, stack top data is placed in register R62, and register R63 represents the address of the next data in the stack top. As a result, in processor 10, the operation of JAVA instruction “iadd” can be emulated with a sub instruction “LDW R61, @(R63+, R0)” to execute the operation of loading 32-bit data stored in the second from the stack top to register R61 and incrementing the contents of register R63 by 4 and a sub instruction “ADD R62, R62, R61” to execute the operation of adding the two 32-bit integers of registers R61 and R62 and writing the result in register R 62. At this time, regarding the PC value, the PC value of processor 10 is advanced by 8 addresses by executing one VLIW instruction, so that advancing the PC value by 1 is emulated corresponding execution of JAVA instruction “iadd”.

Referring to FIG. 27, 2-byte JAVA instruction “iload” is translated to a VLIW instruction to execute one sub instruction “ADDICN R50, #(0||vindex)”, and a VLIW instruction to sequentially execute a sub instruction “STW R62, @(R63−, R4)” and a sub instruction “LDW R62, @(R10, R50)”. The instruction “iload” is a JAVA instruction to fetch a 32-bit integer from a local variable region and put the integer in the stack top. Processor 10 emulates this by dividing it into a sub instruction “ADD/CN R50, #(0||vindex)” to load the index value of a local variable to register R50, a sub instruction “STW R62, @(R63−, R4)” which pushes register R62 to the second from the stack top, and a sub instruction “LDW R62, @(R10, R50)” to load data to register R62 which is the stack top from the local variable region.

Note that register R4 holds a value “−4”, and register R10 holds the base address of the local variable region. Regarding the PC value, the two VLIW instructions are executed to increment the PC value of processor 10 by 16 addresses, so that incrementing the PC value by 2 addresses corresponding to execution of JAVA instruction “iload” is emulated.

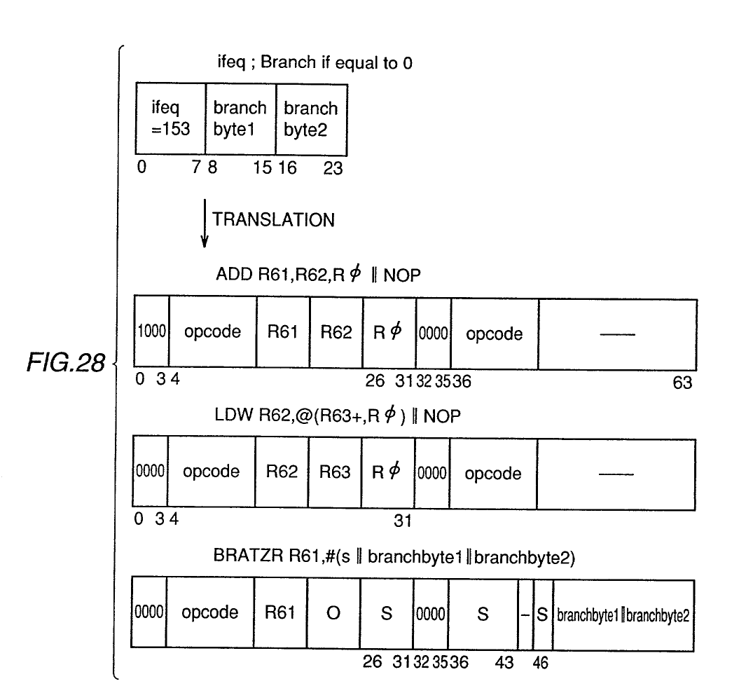

Referring to FIG. 28, 3-byte JAVA instruction “ifeq” is divided into a VLIW instruction to execute a sub instruction “ADD R62, R61, R0” and a sub instruction “NOP” in parallel, a VLIW instruction to execute a sub instruction “LDW R62, @(R63+, R0)” and a sub instruction “NOP” in parallel, and a VLIW instruction to execute one sub instruction “BRATZR/CN R62, #(s||branchbyte1||branchbyte2)”. Instruction “ifeq” is a JAVA instruction to branch if stack top data is “0”. Processor 10 divides this operation into a sub instruction “ADD R61, R62, R0” to copy register R62 to register R61, a sub instruction “LDW R62, @(R63+, R0)” to pop data stored in the second from the stack top to register R62, and a sub instruction “BRATZR/CN R62, #(s||branchbyte1||branchbyte2)”, and combines these three sub instructions and two NOP instructions thereby emulating the operation with three VLIW instructions in total. Regarding the PC value, the three VLIW instructions are executed incrementing the PC value of processor 10 by 24 addresses, so that advancing the PC value by three addresses corresponding to execution of JAVA instruction “ifeq” is emulated.

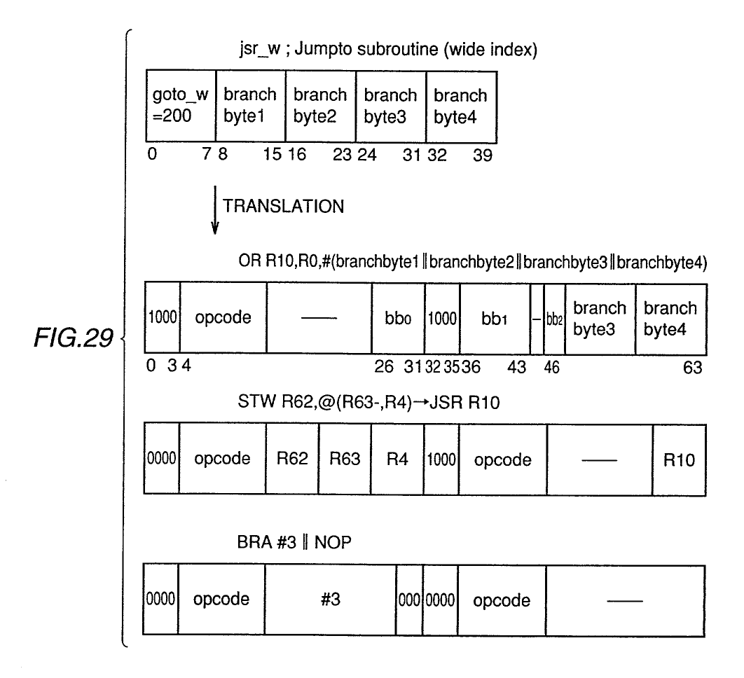

Referring to FIG. 29, a 5-byte JAVA instruction “jsr_w” is translated to a VLIW instruction including one sub instruction “OR R10, #(branchbyte1||branchbyte2||branchbyte3||branchbyte4)”, a VLIW instruction to sequentially execute a sub instruction “STW R62, @(R62−, R4)” and a sub instruction “BSR R10”, and a VLIW instruction to execute a sub instruction “BRA #3” and a sub instruction “NOP” in parallel. “jsr_w” is a JAVA instruction to push a return address to the stack and jump to a subroutine at an address specified by 4 bytes. Processor 10 emulates this instruction by dividing the operation to a sub instruction “OR R10, #(branchbyte1||branchbyte2||branchbyte3||branchbyte4)” to load the jump address to register R10, a sub instruction “STW R62, @(R63−, R4)” to push the value of register R62 at the stack top to the second from the stack top, a sub instruction “JSR R10” to store the return address to register R62, which is the stack top, and jump to a subroutine at the address specified by register R10, a sub instruction “BRA #3” to branch and skip two VLIW instructions after returning from the subroutine, and a sub instruction “NOP”. Regarding the PC value, the three VLIW instructions are executed, the two VLIW instructions are branched and skipped causing the PC value incremented by 40 addresses, so that advancing the PC value by 5 addresses corresponding to execution of JAVA instruction “jsr_w” is emulated.

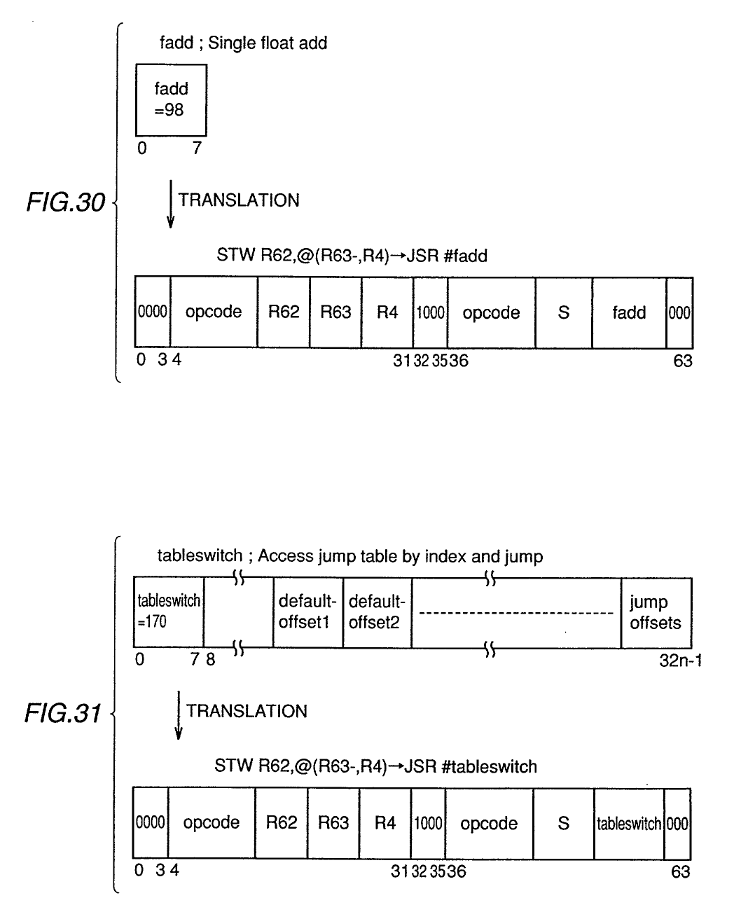

FIGS. 30 and 31 show examples of how a complicated JAVA instruction is translated to a VLIW instruction to call a subroutine including a VLIW instruction and executing the function of the JAVA instruction. Referring to FIG. 30, in this example, a JAVA instruction “fadd” to execute floating point addition is translated to a VLIW instruction to sequentially execute a sub instruction “STW R62, @(R63−, R4)” to push the value of register R62 at the stack top to the second, a sub instruction “JSR #fadd” to store a return address in register R62 at the stack top and jump to a subroutine at an address specified by #fadd. In processor 10, the operation of “fadd” is executed in the subroutine, and regarding updating of the PC value, one VLIW instruction is executed to advance the PC value of processor 10 by 8 addresses, so that incrementing the PC value corresponding to “fadd” by one address is emulated.

In the example shown in FIG. 31, a JAVA instruction “tableswitch” is translated to a VLIW instruction to sequentially execute a sub instruction “STW R62, @(R63−, R4)” to push the value of register R62 at the stack top to the second from the stack top, a sub instruction “JSR #table switch” to store a return address in register R62 at the stack top and jump to a subroutine at an address specified by #tableswitch. In processor 10, the operation of “tableswitch” and updating of the PC value are both emulated by accessing various parameters specified by JAVA instruction “tableswtich” in the subroutine. At this time, processor 10 accesses memory 25 with a translator for JAVA instruction in address region 125a for JAVA instruction (direct) and reads out the various parameters specified by JAVA instruction “tableswitch” as data.

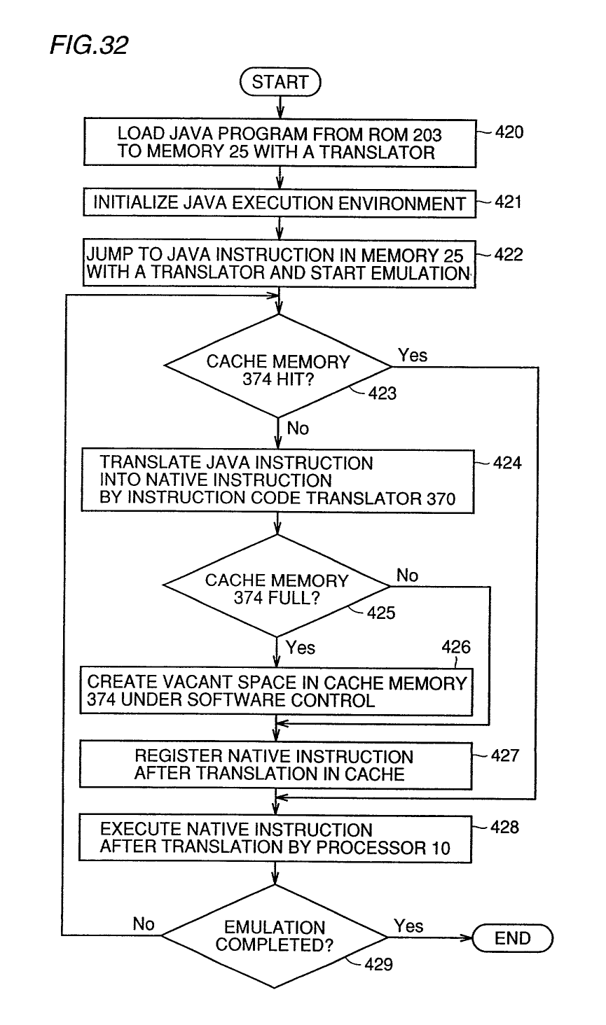

Referring to FIG. 32, when processor 10 emulates a program written in JAVA instructions, using memory 25 with a translator for JAVA instruction, the algorithm for the processing executed by processor 10 has a control structure as follows. Processor 10 loads a JAVA program from ROM 23 to memory 25 with a translator for JAVA instruction (420). Then, processor 10 creates a JAVA instruction execution environment and executes initialization for emulation (421). Then, processor 10 jumps to an address in memory 25 with a translator for JAVA instruction and thus starts emulation (422).

Cache memory 374 is accessed, and for a hit, the control proceeds to step 428 and for a miss, to step 424 (423). For a cache miss, a JAVA instruction is fetched from RAM 265 for JAVA instruction, and the JAVA instruction is translated to a native VLIW instruction at instruction code translation portion 370 (424). If the translated native instruction can be stored in cache memory 374, the control proceeds to step 427. If a corresponding entry in cache memory 374 cannot be fully stored, a FULL signal 381 is asserted to request processor 10 to make an interrupt, and a vacant entry to store the translated native instruction is created in cache memory 374 under software control (425, 426).

Then, processor 10 executes the translated native instruction to emulate the JAVA instruction (428). If the emulation is not completed, the PC value is advanced to access cache memory 374. If the emulation is completed, the operation of memory 25 with a translator for JAVA instruction is completed and the control returns to the program by the native instruction. Here, the process of steps 420 to 422 and 426 is not executed by the process with the translated JAVA instruction, but with the program for the native VLIW instruction present in RAM 21 for native instruction.

Memory 26 with a translator for non-native instruction X is used to translate an instruction X having a fixed, 8-byte length to a VLIW instruction for processor 10 for execution. To processor 10, the addresses for accessing memory 26 with a translator for non-native instruction X, appear to include an address region 126a for non-native instruction X (direct) and an address region 126b for non-native instruction X (via translator) shown in FIG. 11. A valid memory exists at all the byte positions in the space of 64 KB when memory 26 with a translator for non-native instruction X is accessed at any of the address regions. If memory 26 with a translator for non-native instruction X is accessed in address region 126b, instruction X is translated to a VLIW instruction by translator 16 for output. Details of translator 16 are substantially the same as those of translator 14 in FIG. 12. Note however that unlike translator 14, in translator 16, there are no circuits corresponding to address translator 241, and MUX 242 shown in FIG. 12, addresses are not translated before they are input, the cache memory does not have a function corresponding to U bit 382, and one instruction X is translated to one VLIW instruction.

In the embodiment described above, one VLIW instruction is held for each entry of a cache memory. The invention is however not limited to this, and a plurality of VLIW instructions may be held for one entry. Also in the apparatus according to the above embodiment, one byte of a JAVA instruction corresponds to one VLIW instruction for emulation, but two or three VLIW instructions may correspond to one byte of a JAVA instruction for emulation.

Furthermore, in the above embodiment, translated instructions are held in a cache memory by way of illustration. The invention is however not limited to this structure, and the cache memory does not have to be provided. A buffer may be used, which temporarily holds a plurality of VLIW instructions after the translation and invalidates the held content each time it is used.

As in the foregoing, according to the embodiment, a non-native instruction can be translated into a native instruction for execution in a processor without changing the structure of the processor itself, and a translated instruction can be output at a high speed. A program written with non-native instructions can be efficiently emulated.

The value of the program counter for non-native instructions does not have to be explicitly emulated. As a result, programs written with non-native instructions can be readily emulated. In addition, the capacity of the memory to store programs may be small, which prevents increase in the cost of hardware.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. In a processor operating with instructions in a first instruction architecture as a native instruction, an instruction translator used with an instruction memory to store an instruction in a second instruction architecture different from said first instruction architecture, for translating an instruction in said second instruction architecture into an instruction in said first instruction architecture for application to said processor, said instruction translator comprising:
a translator for reading out an instruction from said instruction memory in response to a received first address in said instruction memory of an instruction to be executed by said processor and translating the read out instruction in said second instruction architecture into an instruction in said first instruction architecture;
an instruction cache for temporarily holding the instruction in said first instruction architecture after the translation by said translator in association with the first address in said instruction memory; and
a selector for searching said instruction cache in response to a received second address of an instruction to be executed by said processor, and for selectively outputting, based on a determination result of whether or not an instruction corresponding to the instruction of the second address is held in said instruction cache, an instruction output by said translator and the corresponding instruction held in said instruction cache.

2. The instruction translator according to claim 1, wherein said second instruction architecture is a variable length instruction architecture, and said translator includes a variable length translator for translating an instruction in said second instruction architecture read out from said instruction memory into one or more instructions in said first instruction architecture, the number of which depends on an instruction length of the read out instruction in said second instruction architecture.

3. The instruction translator according to claim 2, wherein said variable length translator translates the instruction in said second instruction architecture read out from said instruction memory into an instruction in said first instruction architecture depending on the instruction length of said read out instruction in said second instruction architecture and having a length larger than the instruction length.

4. The instruction translator according to claim 3, wherein each instruction in said first instruction architecture includes one or a plurality of sub instructions, and the number of the sub instructions included in the instruction in the first instruction architecture translated by said variable length translator depends on the instruction length of said read out instruction in said second instruction architecture.

5. The instruction translator according to claim 1, wherein said translator includes a plurality of translators which translate a plurality of instructions in said second instruction architecture read out from said instruction memory into one instruction in said first instruction architecture.

6. The instruction translator according to claim 1, wherein each instruction in said first instruction architecture can include one or a plurality of sub instructions, and
said translator translates a plurality of instructions in said second instruction architecture read out from said instruction memory into an instruction in said first instruction architecture including sub instructions, the number of which depends on the number of said plurality of instructions.

7. The instruction translator according to claim 6, wherein the number of sub instructions included in the instruction in said first instruction architecture after said translation is equal to the number of said plurality of instructions.

8. The instruction translator according to claim 1, wherein
said translator translates said read out instruction in said second instruction architecture into one or a plurality of instructions as the instruction in said first instruction architecture;
said instruction translator further comprises a controller for controlling said instruction cache so that said instruction cache holds each of said one or said plurality of instructions held in said instruction cache as an entry which can be invalidated in one of first and second conditions.

9. The instruction translator according to claim 8, wherein said first condition is a holding control condition by hardware control based on a prescribed algorithm by said instruction cache, and
said second condition is a condition in which an explicit invalidation instruction is applied from the outside of said instruction cache.

10. The instruction translator according to claim 8, wherein said controller outputs a signal asserted when a new instruction cannot be held in said instruction cache without invalidating an entry which can be invalidated in the second condition.

11. The instruction translator according to claim 8, wherein
said translator translates the read out instruction in said second instruction architecture into the plurality of instructions as the instruction in said first instruction architecture, and said controller provides said first condition with one of said plurality of instructions and said second condition with each of said plurality of instruction but said one instruction.

12. An instruction memory attached with a translator, used with a processor operating with an instruction in a first instruction architecture as a native instruction, comprising:
an instruction storage unit to store an instruction in a second instruction architecture; and
an instruction translator to translate an instruction in said second instruction architecture output from said instruction storage unit into an instruction in said first instruction architecture for application to said processor.

13. The instruction memory attached with a translator according to claim 12, wherein said instruction translator includes a selector to select one of the processing to translate the instruction in said second instruction architecture into the instruction in said first instruction architecture and the processing of outputting the instruction in said second instruction architecture as it is, based on an address of an instruction to be executed which is read out from said instruction storage unit.

14. The instruction memory attached with a translator according to claim 12, further comprising an address translator to translate an address at the time of reading from said instruction storage unit.

15. The instruction memory attached with a translator according to claim 12, wherein said instruction translator includes:
a translator to read out the instruction in said second instruction architecture from said instruction storage unit in response to a received first address of an instruction to be executed by said processor and translate the read out instruction in said second instruction architecture into the instruction in said first instruction architecture;
an instruction cache to temporarily hold the instruction in said first instruction architecture after the translation by said translator in association with the first address; and
a selector to search said instruction cache in response to a received second address of an instruction to be executed by said processor and selectively output to said processor, based on a determination result of whether or not an instruction corresponding to the instruction of the address is held in said instruction cache, an instruction output by said translator and the corresponding instruction in said first instruction architecture held in said instruction cache.

16. A data processing apparatus, comprising:
a processor operating with an instruction in a first instruction architecture as a native instruction;
a bus to which said processor is connected; and
an instruction memory with a translator interconnected with said processor through said bus,
said instruction memory with a translator including:
an instruction storage unit to store an instruction in a second instruction architecture transferred from said processor through said bus; and
an instruction translator to translate the instruction in said second instruction architecture output from said instruction storage unit into an instruction in said first instruction architecture for application to said processor through said bus.

17. The data processing apparatus according to claim 16, further comprising, a second instruction memory interconnected to said processor through said bus, said second instruction memory including:
an instruction storage unit to store an instruction in said first instruction architecture transferred from said processor through said bus; and
an instruction reading circuit responsive to an address signal applied from said processor through said bus for applying an instruction in said first instruction architecture output from said instruction storage unit to said processor through said bus.

18. The data processing apparatus according to claim 15, wherein the wait number of said bus when an instruction read out from said instruction memory with a translator is transferred to said processor is controlled to be larger than the wait number of said bus when an instruction read out from said second instruction memory is transferred to said processor.

19. The data processing apparatus according to claim 18, further comprising a third instruction memory with a translator interconnected to said processor through said bus,
said third instruction memory with a translator including:
an instruction storage unit to store an instruction in a third instruction architecture different from said second instruction architecture, said instruction in said third instruction architecture being transferred from said processor through said bus; and
an instruction translation circuit responsive to an address signal applied from said processor through said bus, for translating an instruction in said third instruction architecture output from said instruction storage into an instruction in said first instruction architecture for application to said processor.
